(19) United States
(12) Patent Application Publication
(10) Pub. No.: US 2024/0121035 A1
(43) Pub. Date: Apr. 11, 2024

(54) REDUNDANCY VERSION CONFIGURATION FOR A PROBABILISTIC CONSTELLATION SHAPING SCHEME

(71) Applicant: QUALCOMM INCORPORATED, San Diego, CA (US)

(72) Inventors: Kexin XIAO, Shanghai (CN); Liangming WU, Beijing (CN); Changlong XU, Beijing (CN); Kangqi LIU, San Diego, CA (US); Jian LI, Shanghai (CN); Hao XU, Beijing (CN); Ruiming ZHENG, Beijing (CN); Wei LIU, Beijing (CN)

(21) Appl. No.: 18/263,671

(22) PCT Filed: Mar. 9, 2021
(86) PCT No.: PCT/CN2021/079641

§ 371 Date: Jul. 31, 2023

(51) Int. Cl. H04L 1/1867

(52) U.S. Cl. CPC H04L 1/189; H04L 1/1874

(57) ABSTRACT

Methods, systems, and devices for wireless communications are described. In some systems, a wireless device may In use non-uniformly distributed bits for amplitude mapping and uniformly distributed bits for sign mapping to support probabilistic constellation shaping (PCS) for transmission of a message. To provide a coding gain with one or more retransmissions of the message, the device may configure redundancy versions based on the non-uniform distribution of one or more symbols. In some examples, the device may include the same set of non-uniformly distributed systematic bits or at least a portion of non-uniformly distributed systematic bits in each redundancy version of the message. Additionally or alternatively, the device may use multiple modulation and coding scheme (MCS) values to modulate one or more of the redundancy versions, where a first MCS value is used to modulate non-uniformly distributed symbols and a second MCS value is used to modulate uniformly distributed symbols.

### CROSS REFERENCE

The present Application is a 371 national stage filing of International PCT Application No. PCT/CN2021/079641 by XIAO et al. entitled “REDUNDANCY VERSION CONFIGURATION FOR A PROBABILISTIC CONSTELLATION SHAPING SCHEME,” filed Mar. 9, 2021, which is assigned to the assignee hereof, and which is expressly incorporated by reference in its entirety herein.

### FIELD OF TECHNOLOGY

The following relates to wireless communications, including a redundancy version configuration for a probabilistic constellation shaping (PCS) scheme.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support a redundancy version configuration for a probabilistic constellation shaping (PCS) scheme. Generally, the described techniques provide for handling retransmissions that support coding gains when using a PCS scheme. In some systems, a wireless device (e.g., a user equipment (UE) or a base station) may use non-uniformly distributed bits for amplitude mapping and uniformly distributed bits for sign mapping to support PCS for an initial transmission of a message (e.g., with a redundancy version index of 0). To provide a coding gain with one or more retransmissions of the message (e.g., with redundancy version indexes greater than 0), the wireless device may configure one or more redundancy versions based on the non-uniform distribution of one or more symbols. In a first example, the wireless device may include a same set of non-uniformly distributed bits (e.g., non-uniformly distributed systematic bits) in each redundancy version of the message to support non-uniformly distributed amplitude mapping, along with a respective subset of parity bits for each redundancy version to support a coding gain. In a second example, the wireless device may include at least a portion of the non-uniformly distributed bits in each redundancy version and may use multiple modulation and coding scheme (MCS) values to modulate one or more of the redundancy versions, where a first MCS value may be used to modulate non-uniformly distributed symbols and a second MCS value may be used to modulate uniformly distributed symbols. In a third example, the wireless device may include any combination of non-uniformly distributed bits and uniformly distributed bits in each redundancy version (e.g., such that a redundancy versions may include no non-uniformly distributed bits), and the wireless device may use the multiple MCS values to modulate one or more of the redundancy versions.

A method for wireless communications at a UE is described. The method may include generating a set of parity bits based on a set of systematic bits for a message, generating a set of multiple redundancy versions of the message, each redundancy version of the set of multiple redundancy versions including the set of systematic bits and a respective subset of the set of parity bits, modulating a set of multiple signals corresponding to the set of multiple redundancy versions of the message based on the set of systematic bits and the respective subset of the set of parity bits for the respective redundancy versions of the set of multiple redundancy versions, and transmitting the set of multiple modulated signals.

An apparatus for wireless communications at a UE is described. The apparatus may include a processor, memory coupled with the processor, and instructions stored in the memory. The instructions may be executable by the processor to cause the apparatus to generate a set of parity bits based on a set of systematic bits for a message, generate a set of multiple redundancy versions of the message, each redundancy version of the set of multiple redundancy versions including the set of systematic bits and a respective subset of the set of parity bits, modulate a set of multiple signals corresponding to the set of multiple redundancy versions of the message based on the set of systematic bits and the respective subset of the set of parity bits for the respective redundancy versions of the set of multiple redundancy versions, and transmit the set of multiple modulated signals.

Another apparatus for wireless communications at a UE is described. The apparatus may include means for generating a set of parity bits based on a set of systematic bits for a message, means for generating a set of multiple redundancy versions of the message, each redundancy version of the set of multiple redundancy versions including the set of systematic bits and a respective subset of the set of parity bits, means for modulating a set of multiple signals corresponding to the set of multiple redundancy versions of the message based on the set of systematic bits and the respective subset of the set of parity bits for the respective redundancy versions of the set of multiple redundancy versions, and means for transmitting the set of multiple modulated signals.

A non-transitory computer-readable medium storing code for wireless communications at a UE is described. The code may include instructions executable by a processor to generate a set of parity bits based on a set of systematic bits for a message, generate a set of multiple redundancy versions of the message, each redundancy version of the set of multiple redundancy versions including the set of systematic bits and a respective subset of the set of parity bits, modulate a set of multiple signals corresponding to the set of multiple redundancy versions of the message based on the set of systematic bits and the respective subset of the set of parity bits for the respective redundancy versions of the set of multiple redundancy versions, and transmit the set of multiple modulated signals.

Some examples of the method, apparatuses, and non-transitory computer-readable medium described herein may further include operations, features, means, or instructions for loading the set of parity bits into a parity bit circular buffer and determining the respective subset of the set of parity bits for each redundancy version of the set of multiple redundancy versions based on the parity bit circular buffer, where generating the set of multiple redundancy versions of the message may be based on determining the respective subset of the set of parity bits for each redundancy version of the set of multiple redundancy versions.

In some examples of the method, apparatuses, and non-transitory computer-readable medium described herein, determining the respective subset of the set of parity bits for each redundancy version may include operations, features, means, or instructions for selecting the respective subset of the set of parity bits sequentially from the set of parity bits loaded into the parity bit circular buffer based on a respective start position for the parity bit circular buffer corresponding to each redundancy version.

Some examples of the method, apparatuses, and non-transitory computer-readable medium described herein may further include operations, features, means, or instructions for determining each respective start position for the parity bit circular buffer corresponding to each redundancy version based on information configured at the UE, the information defining associations between each redundancy version and each respective start position for the parity bit circular buffer.

In some examples of the method, apparatuses, and non-transitory computer-readable medium described herein, each respective start position for the parity bit circular buffer corresponding to each redundancy version may be equally spaced around the parity bit circular buffer relative to the other respective start positions.

In some examples of the method, apparatuses, and non-transitory computer-readable medium described herein, at least one start position of a set of multiple start positions for the parity bit circular buffer corresponding to the set of multiple redundancy versions may be unequally spaced around the parity bit circular buffer relative to at least one other start position of the set of multiple start positions for the parity bit circular buffer.

In some examples of the method, apparatuses, and non-transitory computer-readable medium described herein, modulating the set of multiple signals may include operations, features, means, or instructions for modulating each signal of the set of multiple signals corresponding to a respective redundancy version of the set of multiple redundancy versions of the message using the set of systematic bits for amplitude mapping and the respective subset of the set of parity bits for the respective redundancy version for sign mapping.

Some examples of the method, apparatuses, and non-transitory computer-readable medium described herein may further include operations, features, means, or instructions for determining the amplitude mapping based on a distribution matcher configured with a non-uniform distribution, the determining the amplitude mapping including operations, features, means, or instructions for inputting the systematic bits into the distribution matcher and outputting the systematic bits from the distribution matcher with the non-uniform distribution.

In some examples of the method, apparatuses, and non-transitory computer-readable medium described herein, each of the set of multiple signals may be modulated using a same MCS value.

A method for wireless communications at a UE is described. The method may include generating a set of parity bits based on a set of systematic bits for a message, generating a set of multiple redundancy versions of the message, each redundancy version of the set of multiple redundancy versions including one or more of the set of systematic bits based on a respective systematic bit start position and one or more of the set of parity bits based on a respective parity bit start position, modulating a set of multiple signals corresponding to the set of multiple redundancy versions of the message based on the one or more of the set of systematic bits and the one or more of the set of parity bits for the respective redundancy versions of the set of multiple redundancy versions, and transmitting the set of multiple modulated signals.

An apparatus for wireless communications at a UE is described. The apparatus may include a processor, memory coupled with the processor, and instructions stored in the memory. The instructions may be executable by the processor to cause the apparatus to generate a set of parity bits based on a set of systematic bits for a message, generate a set of multiple redundancy versions of the message, each redundancy version of the set of multiple redundancy versions including one or more of the set of systematic bits based on a respective systematic bit start position and one or more of the set of parity bits based on a respective parity bit start position, modulate a set of multiple signals corresponding to the set of multiple redundancy versions of the message based on the one or more of the set of systematic bits and the one or more of the set of parity bits for the respective redundancy versions of the set of multiple redundancy versions, and transmit the set of multiple modulated signals.

Another apparatus for wireless communications at a UE is described. The apparatus may include means for generating a set of parity bits based on a set of systematic bits for a message, means for generating a set of multiple redundancy versions of the message, each redundancy version of the set of multiple redundancy versions including one or more of the set of systematic bits based on a respective systematic bit start position and one or more of the set of parity bits based on a respective parity bit start position, means for modulating a set of multiple signals corresponding to the set of multiple redundancy versions of the message based on the one or more of the set of systematic bits and the one or more of the set of parity bits for the respective redundancy versions of the set of multiple redundancy versions, and means for transmitting the set of multiple modulated signals.

A non-transitory computer-readable medium storing code for wireless communications at a UE is described. The code may include instructions executable by a processor to generate a set of parity bits based on a set of systematic bits for a message, generate a set of multiple redundancy versions of the message, each redundancy version of the set of multiple redundancy versions including one or more of the set of systematic bits based on a respective systematic bit start position and one or more of the set of parity bits based on a respective parity bit start position, modulate a set of multiple signals corresponding to the set of multiple redundancy versions of the message based on the one or more of the set of systematic bits and the one or more of the set of parity bits for the respective redundancy versions of the set of multiple redundancy versions, and transmit the set of multiple modulated signals.

Some examples of the method, apparatuses, and non-transitory computer-readable medium described herein may further include operations, features, means, or instructions for loading the set of systematic bits and the set of parity bits into a circular buffer, selecting the one or more of the set of systematic bits sequentially from the set of systematic bits loaded into the circular buffer based on the respective systematic bit start position for the circular buffer corresponding to each redundancy version, and selecting the one or more of the set of parity bits sequentially from the set of parity bits loaded into the circular buffer based on the respective parity bit start position for the circular buffer corresponding to each redundancy version, where generating the set of multiple redundancy versions of the message may be based on selecting the one or more of the set of systematic bits sequentially from the set of systematic bits loaded into the circular buffer and selecting the one or more of the set of parity bits sequentially from the set of parity bits loaded into the circular buffer.

Some examples of the method, apparatuses, and non-transitory computer-readable medium described herein may further include operations, features, means, or instructions for determining each respective systematic bit start position and each respective parity bit start position for the circular buffer corresponding to each redundancy version based on information configured at the UE, the information defining associations between each redundancy version, the respective systematic bit start position, and the respective parity bit start position, where selecting the one or more of the set of systematic bits and selecting the one or more of the set of parity bits may be based on determining each respective systematic bit start position and each respective parity bit start position for the circular buffer.

In some examples of the method, apparatuses, and non-transitory computer-readable medium described herein, the associations between each redundancy version, the respective systematic bit start position, and the respective parity bit start position may be independent of MCS values.

In some other examples of the method, apparatuses, and non-transitory computer-readable medium described herein, the information defines the associations between MCS values, each redundancy version, the respective systematic bit start position, and the respective parity bit start position.

In some examples of the method, apparatuses, and non-transitory computer-readable medium described herein, the modulating may include operations, features, means, or instructions for modulating a first portion of the set of multiple signals using a first MCS value, the first portion including a non-uniform distribution for amplitude mapping, and modulating a second portion of the set of multiple signals using a second MCS value, the second portion including a uniform distribution for amplitude mapping.

Some examples of the method, apparatuses, and non-transitory computer-readable medium described herein may further include operations, features, means, or instructions for receiving a downlink control information (DCI) message including a first MCS field indicating the first MCS scheme value and a second MCS field indicating the second MCS value, where modulating the set of multiple signals may be based on the DCI message.

Some examples of the method, apparatuses, and non-transitory computer-readable medium described herein may further include operations, features, means, or instructions for receiving a DCI message including an MCS field indicating an MCS index, where the modulating the set of multiple signals includes operations, features, means, or instructions for modulating a first signal corresponding to an initial transmission of the message using the first MCS value based on initial transmission information defining an association between the MCS index and the first MCS value and modulating one or more additional signals corresponding to one or more retransmissions of the message using the first MCS value, the second MCS value, or both based on retransmission information defining an association between the MCS index and both the first MCS value and the second MCS value.

Some examples of the method, apparatuses, and non-transitory computer-readable medium described herein may further include operations, features, means, or instructions for receiving a first DCI message including a first MCS field indicating the first MCS value and scheduling an initial transmission of the message and receiving a second DCI message including a second MCS field indicating the second MCS value and scheduling a retransmission of the message. In some examples of the method, apparatuses, and non-transitory computer-readable medium described herein, the modulating the set of multiple signals includes operations, features, means, or instructions for modulating a first signal corresponding to the initial transmission of the message using the first MCS value based on the first MCS field and modulating one or more additional signals corresponding to one or more retransmissions of the message using the first MCS value, the second MCS value, or both based on the first MCS field and the second MCS field.

A method for wireless communications at a UE is described. The method may include generating a set of parity bits based on a set of systematic bits for a message and generating a set of multiple redundancy versions of the message, each redundancy version of the set of multiple redundancy versions including one or more of the set of systematic bits, one or more of the set of parity bits, or both. The method may further include modulating a set of multiple signals corresponding to the set of multiple redundancy versions of the message based on the one or more of the set of systematic bits for each redundancy version, the one or more of the set of parity bits for each redundancy version, or both, where the modulating may include modulating a first portion of the set of multiple signals using a first MCS value, the first portion including a non-uniform distribution for amplitude mapping, and modulating a second portion of the set of multiple signals using a second MCS value, the second portion including a uniform distribution for amplitude mapping. The method may further include transmitting the set of multiple modulated signals.

An apparatus for wireless communications at a UE is described. The apparatus may include a processor, memory coupled with the processor, and instructions stored in the memory. The instructions may be executable by the processor to cause the apparatus to generate a set of parity bits based on a set of systematic bits for a message and generate a set of multiple redundancy versions of the message, each redundancy version of the set of multiple redundancy versions including one or more of the set of systematic bits, one or more of the set of parity bits, or both. The instructions may be further executable by the processor to cause the apparatus to modulate a set of multiple signals corresponding to the set of multiple redundancy versions of the message based on the one or more of the set of systematic bits for each redundancy version, the one or more of the set of parity bits for each redundancy version, or both, where the modulating includes modulating a first portion of the set of multiple signals using a first MCS value, the first portion including a non-uniform distribution for amplitude mapping, and modulating a second portion of the set of multiple signals using a second MCS value, the second portion including a uniform distribution for amplitude mapping. The instructions may be further executable by the processor to cause the apparatus to transmit the set of multiple modulated signals.

Another apparatus for wireless communications at a UE is described. The apparatus may include means for generating a set of parity bits based on a set of systematic bits for a message and means for generating a set of multiple redundancy versions of the message, each redundancy version of the set of multiple redundancy versions including one or more of the set of systematic bits, one or more of the set of parity bits, or both. The apparatus may further include means for modulating a set of multiple signals corresponding to the set of multiple redundancy versions of the message based on the one or more of the set of systematic bits for each redundancy version, the one or more of the set of parity bits for each redundancy version, or both, where the modulating may include means for modulating a first portion of the set of multiple signals using a first MCS value, the first portion including a non-uniform distribution for amplitude mapping, and means for modulating a second portion of the set of multiple signals using a second MCS value, the second portion including a uniform distribution for amplitude mapping. The apparatus may further include means for transmitting the set of multiple modulated signals.

A non-transitory computer-readable medium storing code for wireless communications at a UE is described. The code may include instructions executable by a processor to generate a set of parity bits based on a set of systematic bits for a message and generate a set of multiple redundancy versions of the message, each redundancy version of the set of multiple redundancy versions including one or more of the set of systematic bits, one or more of the set of parity bits, or both. The code may further include instructions executable by the processor to modulate a set of multiple signals corresponding to the set of multiple redundancy versions of the message based on the one or more of the set of systematic bits for each redundancy version, the one or more of the set of parity bits for each redundancy version, or both, where the modulating may include modulating a first portion of the set of multiple signals using a first MCS value, the first portion including a non-uniform distribution for amplitude mapping, and modulating a second portion of the set of multiple signals using a second MCS value, the second portion including a uniform distribution for amplitude mapping. The code may further include instructions executable by the processor to transmit the set of multiple modulated signals.

Some examples of the method, apparatuses, and non-transitory computer-readable medium described herein may further include operations, features, means, or instructions for receiving a DCI message including a first MCS field indicating the first MCS value and a second MCS field indicating the second MCS value, where modulating the set of multiple signals may be based on the DCI message.

Some examples of the method, apparatuses, and non-transitory computer-readable medium described herein may further include operations, features, means, or instructions for receiving a DCI message including an MCS field indicating an MCS index, where the modulating the set of multiple signals may include operations, features, means, or instructions for modulating a first signal corresponding to an initial transmission of the message using the first MCS value based on initial transmission information defining an association between the MCS index and the first MCS value and modulating one or more additional signals corresponding to one or more retransmissions of the message using the first

MCS value, the second MCS value, or both based on retransmission information defining an association between the MCS index and both the first MCS value and the second MCS value.

Some examples of the method, apparatuses, and non-transitory computer-readable medium described herein may further include operations, features, means, or instructions for receiving a first DCI message including a first MCS field indicating the first MCS value and scheduling an initial transmission of the message and receiving a second DCI message including a second MCS field indicating the second MCS value and scheduling a retransmission of the message. In some examples of the method, apparatuses, and non-transitory computer-readable medium described herein, the modulating the set of multiple signals may include operations, features, means, or instructions for modulating a first signal corresponding to the initial transmission of the message using the first MCS value based on the first MCS field and modulating one or more additional signals corresponding to one or more retransmissions of the message using the first MCS value, the second MCS value, or both based on the first MCS field and the second MCS field.

Some examples of the method, apparatuses, and non-transitory computer-readable medium described herein may further include operations, features, means, or instructions for loading the set of systematic bits and the set of parity bits into a circular buffer and selecting the one or more of the set of systematic bits, the one or more of the set of parity bits, or both sequentially from the set of systematic bits and the set of parity bits loaded into the circular buffer based on a respective start position for the circular buffer corresponding to each redundancy version.

### BRIEF DESCRIPTION OF THE DRAWINGS

FIGS. 1 and 2 illustrate examples of wireless communications systems that support a redundancy version configuration for a probabilistic constellation shaping (PCS) scheme in accordance with aspects of the present disclosure.

FIGS. 3 through 5 illustrate examples of bit mapping procedures that support a redundancy version configuration for a PCS scheme in accordance with aspects of the present disclosure.

FIG. 6 illustrates an example of a probabilistic amplitude shaping (PAS) process that supports a redundancy version configuration for a PCS scheme in accordance with aspects of the present disclosure.

FIG. 7 illustrates an example of a process flow that supports a redundancy version configuration for a PCS scheme in accordance with aspects of the present disclosure.

FIGS. 8 and 9 show block diagrams of devices that support a redundancy version configuration for a PCS scheme in accordance with aspects of the present disclosure.

FIG. 10 shows a block diagram of a communications manager that supports a redundancy version configuration for a PCS scheme in accordance with aspects of the present disclosure.

FIG. 11 shows a diagram of a system including a device that supports a redundancy version configuration for a PCS scheme in accordance with aspects of the present disclosure.

FIGS. 12 through 15 show flowcharts illustrating methods that support a redundancy version configuration for a PCS scheme in accordance with aspects of the present disclosure.

### DETAILED DESCRIPTION

In some wireless communications systems, a wireless device (e.g., a user equipment (UE), a base station, or both) may use probabilistic constellation shaping (PCS) to modulate a signal. For PCS, the wireless device may use a set of non-uniformly distributed bits for amplitude mapping and a set of uniformly distributed bits for sign mapping during modulation of an initial transmission (e.g., a message with a redundancy version index of 0). In some cases, however, to provide a coding gain with one or more retransmissions of the message, the wireless device may select different bits for additional redundancy versions of the message (e.g., with redundancy version indexes greater than 0). But selecting different bits for different redundancy versions may affect the amount of non-uniformly distributed bits available for amplitude mapping, such that one or more of the redundancy versions of the message may include symbols with uniformly distributed bits not supporting efficient PCS modulation. To provide both a shaping gain (e.g., using PCS) and a coding gain (e.g., using different redundancy versions of a message) for transmissions, the wireless device may perform one or more techniques described herein for a redundancy version configuration to support a PCS scheme.

In a first example, a wireless device may include a same set of non-uniformly distributed bits (e.g., non-uniformly distributed systematic bits) in each redundancy version of a message. The wireless device may determine different subsets of parity bits to include in each redundancy version of the message to support a coding gain. In some cases, the wireless device may use a parity bit-specific circular buffer for selecting the different subsets of parity bits to include in each redundancy version. Based on using the same set of non-uniformly distributed bits in each redundancy version, each redundancy version may include non-uniformly distributed symbols (and may not include uniformly distributed symbols). Accordingly, the wireless device may include non-uniform bits for amplitude mapping and uniform bits for sign mapping for each redundancy version, supporting the shaping gain provided by PCS. The wireless device may transmit each redundancy version of the message using a same modulation and coding scheme (MCS) value.

In a second example, the wireless device may balance a shaping gain and a coding gain for redundancy version transmissions by including at least a portion of the non-uniformly distributed bits (e.g., non-uniformly distributed systematic bits) in each redundancy version of the message. In some cases, the wireless device may use a respective systematic bit start position and a respective parity bit start position for each redundancy version of the message. The wireless device may use different MCS values for transmission of different portions of the redundancy versions of the message. For example, the wireless device may use a first MCS value to modulate portions of the signals with non-uniformly distributed amplitude mapping and may use a second MCS value to modulate portions of the signals with uniformly distributed amplitude mapping.

In a third example, the wireless device may use a same redundancy version selection procedure for transmissions with non-uniformly distributed bits as for transmissions with uniformly distributed bits, supporting a coding gain provided by retransmitting different redundancy versions. The wireless device may use different MCS values for transmission of different portions of the redundancy versions of the message. For example, the wireless device may use a first MCS value to modulate portions of the signals with non-uniformly distributed amplitude mapping and may use a second MCS value to modulate portions of the signals with uniformly distributed amplitude mapping. In some cases, a specific redundancy version may include non-uniformly distributed amplitude mapping and may be modulated using the first MCS value, may include uniformly distributed amplitude mapping and may be modulated using the second MCS value, or may include a first portion with non-uniformly distributed amplitude mapping and a second portion with uniformly distributed amplitude mapping and may be modulated using both the first MCS value (e.g., for the first portion) and the second MCS value (e.g., for the second portion).

Aspects of the disclosure are initially described in the context of wireless communications systems. Additional aspects of the disclosure are described with reference to bit mapping procedures, a probabilistic amplitude shaping (PAS) process, and a process flow. Aspects of the disclosure are further illustrated by and described with reference to apparatus diagrams, system diagrams, and flowcharts that relate to redundancy version configuration for a PCS scheme.

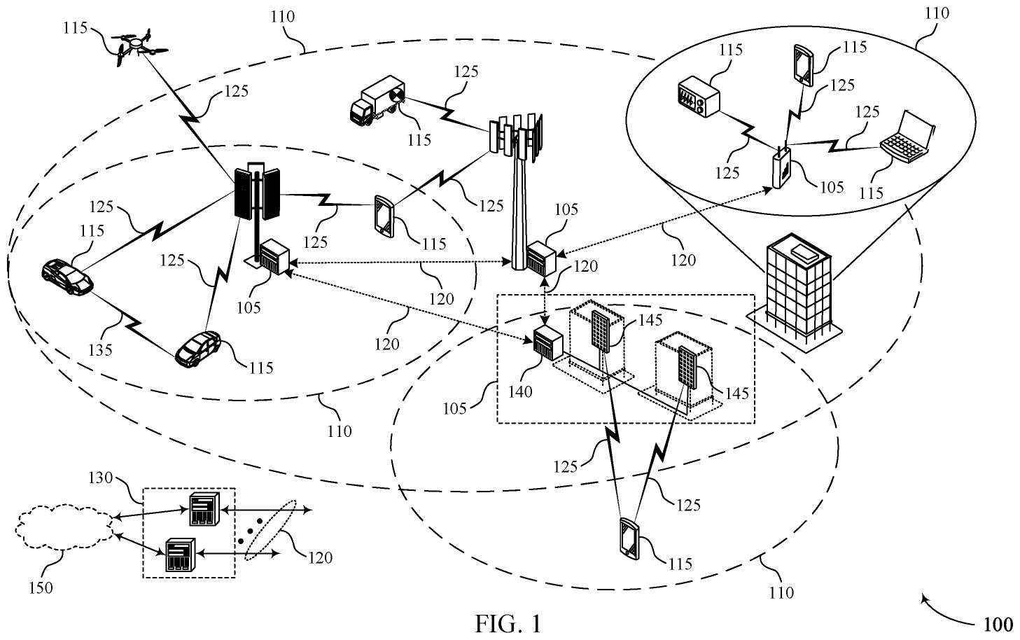

FIG. 1 illustrates an example of a wireless communications system 100 that supports a redundancy version configuration for a PCS scheme in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ−1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some wireless communications systems 100, a wireless device (e.g., a UE 115, a base station 105) may use PCS to modulate a signal. For PCS, the wireless device may use a set of non-uniformly distributed bits for amplitude mapping and a set of uniformly distributed bits for sign mapping during modulation of an initial transmission (e.g., a message with a redundancy version index of 0). However, in some cases, to provide a coding gain with one or more retransmissions of the message, the wireless device may select different bits for additional redundancy versions of the message (e.g., with redundancy version indexes greater than 0). Selecting different bits for different redundancy versions may affect the amount of non-uniformly distributed bits available for amplitude mapping. To support modulation of such redundancy versions, the wireless device may perform redundancy version configuration for a PCS scheme. In some examples, the wireless device may include the same set of non-uniformly distributed bits (e.g., source bits or other bits) or at least a portion of non-uniformly distributed bits in each redundancy version of the message. Additionally or alternatively, the device may use multiple MCS values to modulate one or more of the redundancy versions, where a first MCS value may be used to modulate non-uniformly distributed symbols and a second MCS value may be used to modulate uniformly distributed symbols. In some cases, a UE 115 may determine multiple MCS values to use based on a downlink control information (DCI) message received from a base station 105.

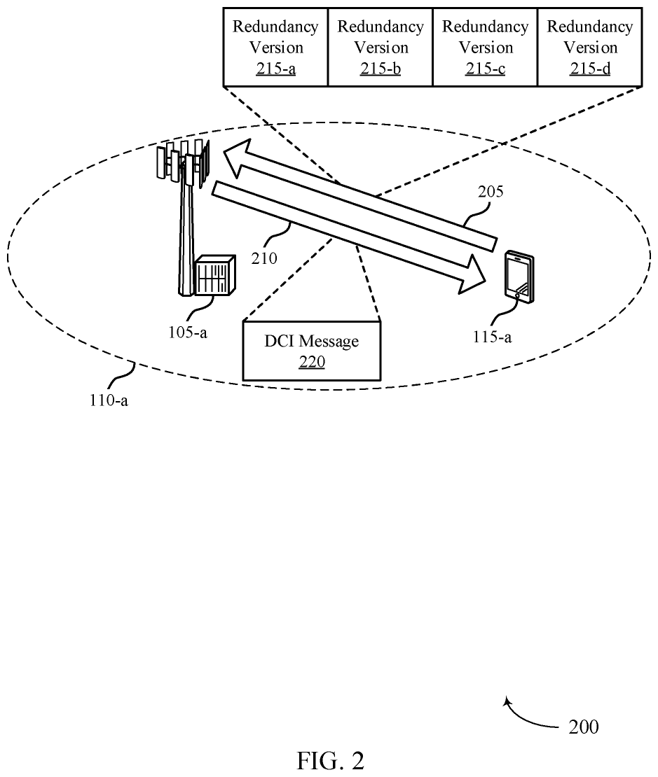

FIG. 2 illustrates an example of a wireless communications system 200 that supports a redundancy version configuration for a PCS scheme in accordance with aspects of the present disclosure. The wireless communications system 200 may be an example of a wireless communications system 100 as described with reference to FIG. 1. For example, the wireless communications system 200 may include a UE 115-a and a base station 105-a, which may be examples of the corresponding devices described with reference to FIG. 1. The base station 105-a may provide service for a coverage area 110-a. The UE 115-a, the base station 105-a, or both may generate redundancy versions 215 of a message for retransmission to support a shaping gain and a coding gain for retransmission.

In some examples, a wireless device (e.g., a UE 115-a or a base station 105-a) may perform constellation shaping for a quadrature amplitude modulation (QAM) transmission. The wireless device may approach the Shannon capacity for a channel by using non-uniformly distributed symbols (e.g., as opposed to using uniformly distributed symbols, which may be approximately 1.53 decibels (dB) below the Shannon capacity). In some cases, the wireless device may use a Gaussian distribution of constellation symbols for improved performance, such as geometric constellation shaping (GCS) or PCS. GCS may involve an equal probability constellation with a Gaussian amplitude distribution. PCS may involve a uniform QAM constellation with non-equal probabilities for points in the constellation. Using PCS for QAM transmissions may effectively improve channel throughput (e.g., for an uplink channel 205, a downlink channel 210, or both).

To transmit information, a wireless device may generate a set of source bits representing the information. In some examples, the wireless device may puncture one or more bits from the set of source bits, calculate one or more checking bits (e.g., error check bits, such as cyclic redundancy check (CRC) bits) using the set of source bits and a checking function (e.g., CRC function), or both. The resulting bits (e.g., the source bits and CRC bits remaining after the puncturing) may be referred to as systematic bits or information bits. Alternatively, in some cases, the set of source bits may be referred to as information bits. The wireless device may calculate a set of parity bits based on the systematic bits. In some cases, the parity bits may include repeated bits from the systematic bits or other information indicating the correct decoding of the systematic bits.

To support PCS for a signal transmission, a wireless device may use a first set of bits with a non-uniform distribution for amplitude mapping and a second set of bits with a uniform distribution for sign mapping. For a specific channel condition, such as a same signal-to-noise ratio (SNR) value, non-uniform signals may support improved error performance as compared to uniform signals. The wireless device may include a distribution matcher which may output bits with a specific (non-uniform) distribution. In some examples, the first set of bits may include systematic bits and the second set of bits may include parity bits. In some other examples, the second set of bits may additionally include some uniformly distributed systematic bits, such as source bits, CRC bits, or some combination thereof. For example, the first set of bits may include a portion of the systematic bits that are sent through the distribution matcher, and the second set of bits may include a portion of the systematic bits and any parity bits that are not sent through the distribution matcher.

Transmitting a first message using PCS may support a significant shaping gain due to the non-uniform amplitude mapping and the uniform sign mapping. However, for retransmissions of the message, a wireless device in some systems may select different start positions from the set of systematic and parity bits to provide a coding gain. If the coded bits for each code block after rate matching are uniformly distributed, selecting different start positions for different redundancy versions of a message may improve the coding gain without negatively affecting the shaping gain. However, for a wireless device performing PCS for signal transmissions, selecting different start positions within the set of systematic and parity bits may affect the combination of uniformly and non-uniformly distributed bits selected. In some examples, to support both a shaping gain and a coding gain at a retransmission stage for a PCS transmission scheme, a wireless device may use one or more redundancy version configuration techniques to combine systematic bits and parity bits in one or more message retransmissions.

A wireless device (e.g., a UE 115-a, a base station 105-a) may generate bits for transmission in one or more redundancy versions 215 of a message. The first redundancy version 215-a of a message (e.g., Redundancy Version 0) may correspond to an initial transmission of the message. One or more additional redundancy versions 215 of the message (e.g., Redundancy Versions 1 through N−1) may correspond to retransmissions of the message, where the number of redundancy versions 215 for a message may be denoted as N. For example, the UE 115-a may be configured to transmit 4 redundancy versions for a message, redundancy version 215-a, redundancy version 215-b, redundancy version 215-c, and redundancy version 215-d. The UE 115-a may select different sets of bits to transmit in the different redundancy versions 215 to support a coding gain at the base station 105-a. For example, each successive redundancy version 215 received at the base station 105-a may provide information related to additional bits associated with the message, improving decoding reliability at the base station 105-a. The base station 105-a may receive one or more of the redundancy versions 215 of the message and may decode the source bits and—correspondingly—the information indicated by the UE 115-a using the received one or more redundancy versions 215.

In a first example, the UE 115-a may include the full set of non-uniformly distributed systematic bits in each redundancy version 215 of the message. The UE 115-a may determine different subsets of parity bits to include in each redundancy version 215 of the message to support a coding gain. In some cases, the UE 115-a may use a parity bit-specific circular buffer for selecting the different subsets of parity bits to include in each redundancy version 215. Based on using the full set of non-uniformly distributed systematic bits in each redundancy version 215, the UE 115-a may include non-uniform bits for amplitude mapping and uniform bits for sign mapping for each redundancy version 215, supporting the shaping gain provided by PCS. The UE 115-a may transmit each redundancy version 215 of the message using a same MCS value.

In a second example, the UE 115-a may balance a shaping gain and a coding gain for redundancy version 215 transmissions by including at least a portion of the non-uniformly distributed systematic bits in each redundancy version 215 of the message. In some cases, the UE 115-a may use a respective systematic bit start position and a respective parity bit start position for each redundancy version 215 of the message. The UE 115-a may use different MCS values for transmission of different portions of the redundancy versions 215 of the message. For example, the UE 115-a may use a first MCS value for portions of the signals with non-uniformly distributed amplitude mapping and may use a second MCS value for portions of the signals with uniformly distributed amplitude mapping.

In a third example, the UE 115-a may use a same redundancy version 215 selection procedure for transmissions with non-uniformly distributed systematic bits and for transmissions with uniformly distributed systematic bits, supporting a coding gain provided by redundancy version retransmissions. The UE 115-a may use different MCS values for transmission of different portions of the redundancy versions 215 of the message. For example, the UE 115-a may use a first MCS value for portions of the signals with non-uniformly distributed amplitude mapping and may use a second MCS value for portions of the signals with uniformly distributed amplitude mapping.

In some examples, the UE 115-a may determine multiple MCS values for transmission of a message based on a DCI message 220. A base station 105-a may transmit the DCI message 220 to the UE 115-a. In some cases, the DCI message 220 may indicate parameters for the message transmission, including a resource allocation and other information. In some examples, the DCI message 220 may include multiple MCS value fields, where a first MCS value field may indicate the first MCS value for portions of signals with non-uniformly distributed amplitude mapping and a second MCS value field may indicate the second MCS value for portions of signals with uniformly distributed amplitude mapping. In some other examples, the DCI message 220 may include an MCS value field indicating an MCS index, and the UE 115-a may include information (e.g., a lookup table) mapping the MCS index to multiple MCS values. In yet some other examples, the base station 105-a may transmit multiple DCI messages 220 to the UE 115-a, where a first DCI message 220 may include an MCS value field indicating the first MCS value for portions of the signals with non-uniformly distributed amplitude mapping and a second DCI message 220 may include an MCS value field indicating the second MCS value for portions of the signals with uniformly distributed amplitude mapping. The UE 115-a may receive the one or more DCI messages 220 on the downlink channel 210 and may determine one or more modulation schemes for transmitting the initial transmission of the message (e.g., redundancy version 215-a) and one or more retransmissions of the message (e.g., redundancy version 215-b, redundancy version 215-c, and redundancy version 215-d), for example, on the uplink channel 205.

In some examples, the UE 115-a may be configured with a single redundancy version configuration technique. In some other examples, the base station 105-a may dynamically configure the UE 115-a with a redundancy version configuration technique (e.g., based on one or more channel parameters, capabilities of the UE, message parameters, or a combination thereof) for improved flexibility.

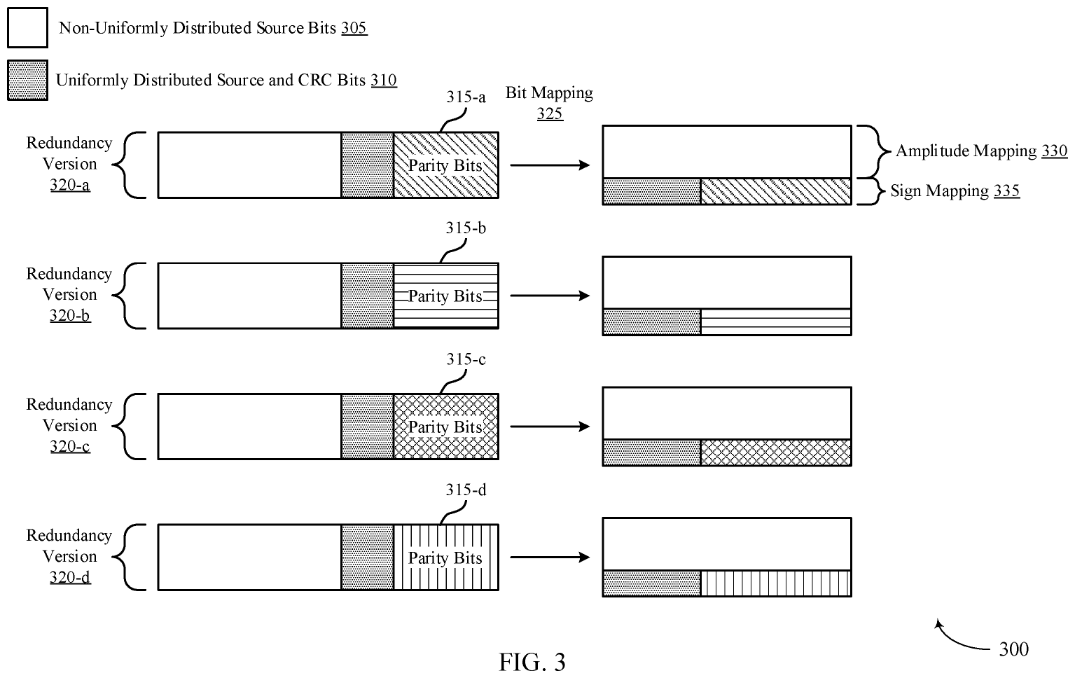

FIG. 3 illustrates an example of a bit mapping procedure 300 that supports a redundancy version configuration for a PCS scheme in accordance with aspects of the present disclosure. The bit mapping procedure 300 may be performed by a wireless device, such as a UE 115 or a base station 105, in a wireless communications system 100 or 200, as described with reference to FIGS. 1 and 2. The wireless device may use a same MCS value for transmitting a set of redundancy versions 320 of a message based on using the bit mapping procedure 300.

The wireless device may generate a set of systematic bits and a set of parity bits for transmission. The wireless device may determine a set of source bits indicating information for transmission to another wireless device. In some cases, the wireless device may include a puncturing component that may puncture a set of bits (e.g., 2Z bits) from the source bits. The wireless device may determine a set of checking bits (e.g., CRC bits) based on the source bits (e.g., before puncturing or after puncturing) and a checking function (e.g., CRC function). In some examples, the wireless device may use low-density parity-check (LDPC) encoding to determine a set of parity bits based on the systematic bits. In some other examples, the wireless device may use other encoding techniques to determine the parity bits.

To support a PCS scheme for transmission, a first portion of the bits (e.g., a subset of the systematic bits and the parity bits) may be configured with a non-uniform probability distribution while a second portion of the bits may be configured with a uniform probability distribution. In some examples, the wireless device may input the first portion of the bits into a distribution matcher, where the distribution matcher outputs the bits with a configured non-uniform distribution. The wireless device may refrain from inputting the second portion of the bits into the distribution matcher. In some cases, the first portion of the bits may include the systematic bits and the second portion of the bits may include the parity bits. In some other cases, the first portion of the bits may include a first subset of the systematic bits and the second portion of the bits may include a second subset of the systematic bits (e.g., source bits, CRC bits, or both) and the parity bits. In yet some other cases, the first portion of the bits may include a combination of the systematic bits and a portion of the parity bits. In some cases, the wireless device may configure the bits with either a non-uniform distribution or a uniform distribution according to a rate matching procedure (e.g., to adjust a coding rate of a transmission).

In some examples, the encoding process may result in non-uniformly distributed source bits 305, uniformly distributed source and CRC bits 310, and uniformly distributed parity bits 315. The wireless device may generate a set of redundancy versions 320 of a message using the generated bits. To support the bit mapping procedure 300, the wireless device may include the set of systematic bits (e.g., the non-uniformly distributed source bits 305 and the uniformly distributed source and CRC bits 310) in each redundancy version 320 of the message. However, the wireless device may include different parity bits 315 in each redundancy version 320 of the message. For example, the wireless device may generate a set of parity bits based on the systematic bits and may include a respective subset of the set of parity bits in each redundancy version 320 of the message. Accordingly, for each redundancy version 320 of a message, the wireless device may maintain the complete set of systematic bits and may add a different set of parity bits 315 after the systematic bits. As illustrated, the redundancy version 320-a may include a first subset of the set of parity bits 315-a, the redundancy version 320-b may include a second subset of the set of parity bits 315-b, the redundancy version 320-c may include a third subset of the set of parity bits 315-c, and the redundancy version 320-d may include a fourth subset of the set of parity bits 315-d.

In some cases, the wireless device may use a parity bit circular buffer to determine the different subsets of the set of parity bits 315 for each redundancy version 320 of the message. The wireless device may load the generated parity bits into the parity bit circular buffer. However, the wireless device may refrain from loading the systematic bits into the parity bit circular buffer. Instead, for each redundancy version 320, the wireless device may select a subset of parity bits 315 from the parity bit circular buffer according to a respective start position for the parity bit circular buffer (e.g., independent of the systematic bits included in the specific redundancy version 320).

The parity bit circular buffer may be configured with a length Nₚ equal to the quantity of parity bits generated based on the set of systematic bits. The wireless device may be configured with information indicating a start position within the parity bit circular buffer for each redundancy version 320. In some examples, the wireless device may store a lookup table mapping redundancy version indexes to parity bit start positions. In some cases, the lookup table may further include different parity bit start positions for different LDPC graphs (e.g., LDPC base graph 1 and LDPC base graph 2) for a given redundancy version 320 index. In a first example, the start position within the parity bit circular buffer for each redundancy version 320 may be assigned with an equal space. For example, the start position x for a redundancy version index i may be defined as x=i*Nₚ/N for N redundancy versions, where the index i is a value from 0 to N−1. In a second example, the start position within the parity bit circular buffer for at least one redundancy version 320 may be assigned with an unequal space, for example, according to some formula or metric. In some cases, the order of redundancy versions 320 may be permuted, such that a wireless device may transmit redundancy versions 320 of a message in a non-ascending order. For example, the wireless device may transmit redundancy version 320-a with index 0, then redundancy version 320-c with index 2, then redundancy version 320-b with index 1, and then redundancy version 320-d with index 3.

The wireless device may perform bit mapping 325 from the bits assigned for each redundancy version 320 to signals to transmit. The bit mapping 325 may map multiple bits to a same symbol, where the bits indicate different information about the symbol (e.g., an amplitude and a sign of the symbol). In some cases, the wireless device may determine the symbols for a signal using the non-uniformly distributed source bits 305 for amplitude mapping 330 and using the uniformly distributed source and CRC bits 310 and the uniformly distributed parity bits 315 for sign mapping 335. Accordingly, each redundancy version 320 for the message may include the non-uniform distribution for amplitude mapping 330, supporting the shaping gain of a PCS scheme. The wireless device may transmit each redundancy version 320 of the message using a same MCS value (e.g., the same MCS method as used for the initial transmission, redundancy version 320-a) based on the symbols each including the non-uniform distribution for amplitude mapping 330.

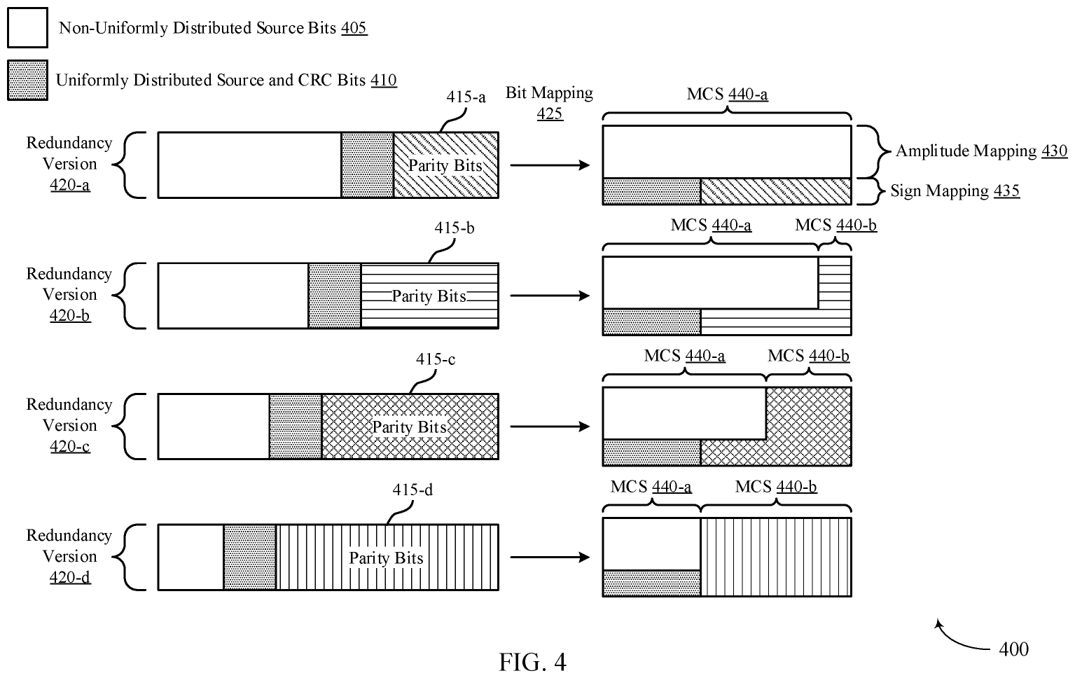

FIG. 4 illustrates an example of a bit mapping procedure 400 that supports a redundancy version configuration for a PCS scheme in accordance with aspects of the present disclosure. The bit mapping procedure 400 may be performed by a wireless device, such as a UE 115 or a base station 105, in a wireless communications system 100 or 200, as described with reference to FIGS. 1 and 2. The wireless device may determine a set of systematic bits and a set of parity bits for a message, for example, according to a process as described herein with reference to FIG. 3. The wireless device may balance a shaping gain provided by a PCS scheme and a coding gain provided by redundancy versions 420 by including at least a portion of the systemic bits and at least a portion of the parity bits in each redundancy version 420 of a message.

In some examples, the wireless device may include at least a portion of the non-uniformly distributed source bits 405 in each redundancy version 420 of the message. In some cases, the wireless device may include the uniformly distributed source and CRC bits 410 in each redundancy version 420. Alternatively, the wireless device may include at least a portion of the uniformly distributed source and CRC bits 410 in each redundancy version 420 or may refrain from including any uniformly distributed source and CRC bits 410 in one or more redundancy versions 420 of the message. The wireless device may further include a respective subset of the set of parity bits 415 in each redundancy version 420 of the message. For example, the wireless device may include a first subset of the set of parity bits 415-a in a first redundancy version 420-a, a second subset of the set of parity bits 415-b in a second redundancy version 420-b, a third subset of the set of parity bits 415-c in a third redundancy version 420-c, and a fourth subset of the set of parity bits 415-d in a fourth redundancy version 420-d. In some cases, the number of systematic bits and the number parity bits 415 included in each redundancy version 420 may vary according to the redundancy version 420 index.

The wireless device may be configured with information indicating a systematic bit start position and a parity bit start position associated with a redundancy version 420 index. For example, the wireless device may store a lookup table including associations between a redundancy version 420 index, i, a systematic bit start position, k0, and a parity bit start position, k1. In some examples, the wireless device may load both the systematic bits and the parity bits into a shared circular buffer and may select bits from the circular buffer for a redundancy version 420 of a message according to the systematic bit start position and the parity bit start position. The portions of bits selected from the circular buffer according to the systematic bit start position and the parity bit start position may not be continuous in the shared circular buffer. In some cases, the wireless device may select the bits from the circular buffer according to a first quantity of bits to select starting with the systematic bit start position and a second quantity of bits to select starting with the parity bit start position. In some examples, the first quantity of bits and the second quantity of bits may be based on the redundancy version 420 index.

Additionally or alternatively, the wireless device may include two buffers, one for the systematic bits and one for the parity bits. The wireless device may select, for a redundancy version 420 of a message, a set of bits from the systematic bit buffer based on the systematic bit start position and may select a set of bits from the parity bit buffer based on the parity bit start position. In some examples, the systematic bit buffer may not be circular, such that the wireless device may select a subset of the systematic bits from the systematic bit buffer starting with the systematic bit start position and ending with a last bit stored in the systematic bit buffer. In some such examples, the wireless device may select a quantity of parity bits from the parity bit buffer (e.g., a circular buffer or non-circular buffer) based on the quantity of bits selected from the systematic bit buffer. In some other examples, the wireless device may determine a first quantity of bits to select starting with the systematic bit start position and a second quantity of bits to select starting with the parity bit start position based on the redundancy version 420 index.

The wireless device may perform bit mapping 425 from the bits assigned for each redundancy version 420 to signals to transmit. The bit mapping 425 may map multiple bits to a same symbol, where the bits indicate different information about the symbol (e.g., an amplitude and a sign of the symbol). In some cases, the wireless device may determine the symbols for a signal using the non-uniformly distributed source bits 405 for amplitude mapping 430 and using the uniformly distributed source and CRC bits 410 and the uniformly distributed parity bits 415 for sign mapping 435. In some examples, based on the quantity of non-uniformly distributed bits selected for a specific redundancy version 420 of a message, the bits for the redundancy version 420 may not support using non-uniformly distributed bits for the amplitude mapping 430 for each symbol. Instead, a first portion of the signal may include symbols with non-uniformly distributed amplitude mapping 430 and a second portion of the signal may include symbols with uniformly distributed amplitude mapping 430.

To transmit a signal including one or more first symbols with non-uniformly distributed amplitude mapping 430 and one or more second symbols with uniformly distributed amplitude mapping 430, the wireless device may use different MCS values 440 for the first symbols and for the second symbols (e.g., based on the different constellation shaping). In some examples, the wireless device may be configured with a first MCS value 440-a for a first portion of the signal including a non-uniform distribution for amplitude mapping 430 and a second MCS value 440-b for a second portion of the signal including a uniform distribution for amplitude mapping 430. The wireless device may modulate the first portion of the signal using the first MCS value 440-a and may modulate the second portion of the signal using the second MCS value 440-b. The portion of each signal corresponding to a non-uniform distribution or a uniform distribution may vary based on the specific redundancy version 420. In some cases, the wireless device may modulate a signal for a redundancy version 420 using a single MCS value 440 (e.g., MCS value 440-a or MCS value 440-b) based on using either a non-uniform distribution or a uniform distribution for the full amplitude mapping 430 of the redundancy version 420.

One or more DCI messages may indicate the first MCS value 440-a and the second MCS value 440-b. In a first example, a DCI message scheduling an initial message transmission (e.g., transmission of the first redundancy version 420-a with a redundancy version index of 0) may include two MCS values, a first MCS value for non-uniformly distributed portions of the signals (e.g., including the first redundancy version 420-a) and a second MCS value for uniformly distributed portions of the signals. In a second example, the DCI message scheduling the initial message transmission (e.g., transmission of the first redundancy version 420-a with a redundancy version index of 0) may include an MCS value 440-a for the first redundancy version 420-a and, correspondingly, the non-uniformly distributed portions of the signals (e.g., including for other redundancy versions 420). A DCI message scheduling a retransmission of the message (e.g., transmission of a redundancy version 420 with a redundancy version index greater than 0) may include an MCS value 440-b for the uniformly distributed portions of the signals (e.g., including for other redundancy versions 420).

A wireless device may use an MCS table to map from an MCS index to one or more modulation and coding parameters (e.g., for rate adaptive modulation and coding). For example, the MCS table may define a modulation order, a target code rate, a spectral efficiency, or some combination thereof for each MCS index. Additionally, to support probability shaping for PCS, the MCS table may include a probability distribution control parameter, V, related to controlling the distribution of a constellation. The MCS table may include a probability distribution control parameter, V, for each MCS index. In some cases, the wireless device may use the value of V for constant composition distribution matching (CCDM) (e.g., where the parameter V controls a distribution value), prefix-free code distribution matching (PCDM) (e.g., where the parameter V is further associated with a mapping table), or both.

In some examples, the wireless device may use a same MCS table to determine MCSs for an initial transmission (e.g., with a redundancy version 420 index of 0) and for retransmissions (e.g., with redundancy version 420 indexes greater than 0). The wireless device may use a single MCS indication (e.g., a first MCS indication) for the initial transmission. For example, the wireless device may receive a DCI message including an MCS field indicating a value. In some cases, the MCS field value may be an example of a 5-bit value indicating an index in the MCS table. For retransmissions, the wireless device may use the first MCS indication and the MCS table to determine an MCS value 440-a for non-uniformly distributed portions of the signals and may use a second MCS indication (e.g., received in the same DCI message or another DCI message) and the MCS table to determine an MCS value 440-b for uniformly distributed portions of the signals. In some cases, the MCS value 440-b may be selected from a reserved portion of the MCS table, such as MCS indexes 28, 29, 30, and 31. If a redundancy version 420 does not include any non-uniformly distributed symbols, the wireless device may use the MCS value 440-b for the entire signal (e.g., setting the MCS value for the message equal to MCS value 440-b).

In some other examples, the wireless device may use different MCS tables to determine an MCS for an initial transmission (e.g., with a redundancy version 420 index of 0) and to determine one or more MCSs for retransmissions (e.g., with redundancy version 420 indexes greater than 0). For example, a first MCS table for an initial transmission may map an MCS index to a modulation order and a priori probability distribution (e.g., V) for the initial transmission. An example of the first MCS table is illustrated by Table 1. Table 1 includes multiple values for V for some MCS indexes; in some cases, Table 1 may represent an MCS table used for both initial transmissions and retransmissions, where the first value for V may be used for an initial transmission and the second value for V may be used for a retransmission. In some other cases (e.g., if Table 1 represent an MCS table for initial transmissions), Table 1 may include a single value for V per MCS index.

TABLE 1
Example First MCS Table

| MCS | Modulation Order | V | Coding Rate |
|---|---|---|---|
| 0 | 2 | 0 | 0.5 |
| 1 | 4 | 0, 0.02 | 0.5 |
| 2 | 4 | 0, 0.01 | 0.5 |
| 3 | 8 | 0, 0.02 | 0.6 |
| 4 | 8 | 0, 0.01 | 0.7 |
| . . . | | | |
| 28 | 2 | reserved | reserved |
| 29 | 4 | reserved | reserved |
| 30 | 4 | reserved | reserved |
| 31 | 8 | reserved | reserved |

A second MCS table for retransmissions may map an MCS index to a first modulation order (e.g., Order1), a first priori probability distribution (e.g., V1), a second modulation order (e.g., Order2), and a second priori probability distribution (e.g., V2). The first modulation order and first priori probability distribution may indicate the modulation type and priori probability distribution for the non-uniformly distributed portions of a signal, and the second modulation order and second priori probability distribution may indicate the modulation type and priori probability distribution for the uniformly distributed portions of a signal. An example of the second MCS table is illustrated by Table 2.

TABLE 2
Example Second MCS Table

| MCS | Order1 | V1 | Order2 | V2 |
|---|---|---|---|---|
| 1 | 2 | 0 | 2 | 0 |
| 2 | 4 | 0.01 | 4 | 0 |
| 3 | 4 | 0.03 | 4 | 0 |
| 4 | 8 | 0.02 | 8 | 0.02 |

If a retransmission (e.g., with a redundancy version 420 index greater than 0) does not have non-uniformly distributed symbols, the wireless device may set V1=0. If a retransmission does not have uniformly distributed symbols, the wireless device may set V2=V1. The priori probability distribution (e.g., a probability distribution control parameter) may be used by a wireless device for deriving the priori information and demodulation of a message.

In some cases, the start positions for bit selection may be fixed across modulation schemes. For example, the wireless device may store a systematic bit start position and a parity bit start position associated with each redundancy version 420 index (e.g., independent of an MCS value 440). In some other cases, the start positions may be dependent on an MCS value 440. For example, the wireless device may use different start positions for a given redundancy version 420 index based on the MCS value 440 (e.g., the MCS value 440-a assigned for an initial message transmission). In some examples, the wireless device may store information (e.g., a lookup table) indicating a mapping between MCS values 440 (e.g., an MCS value 440-a indicated in a DCI message for an initial message transmission with a redundancy version 420 index of 0) and start positions (e.g., systematic bit and parity bit start positions) for each redundancy version 420 index.

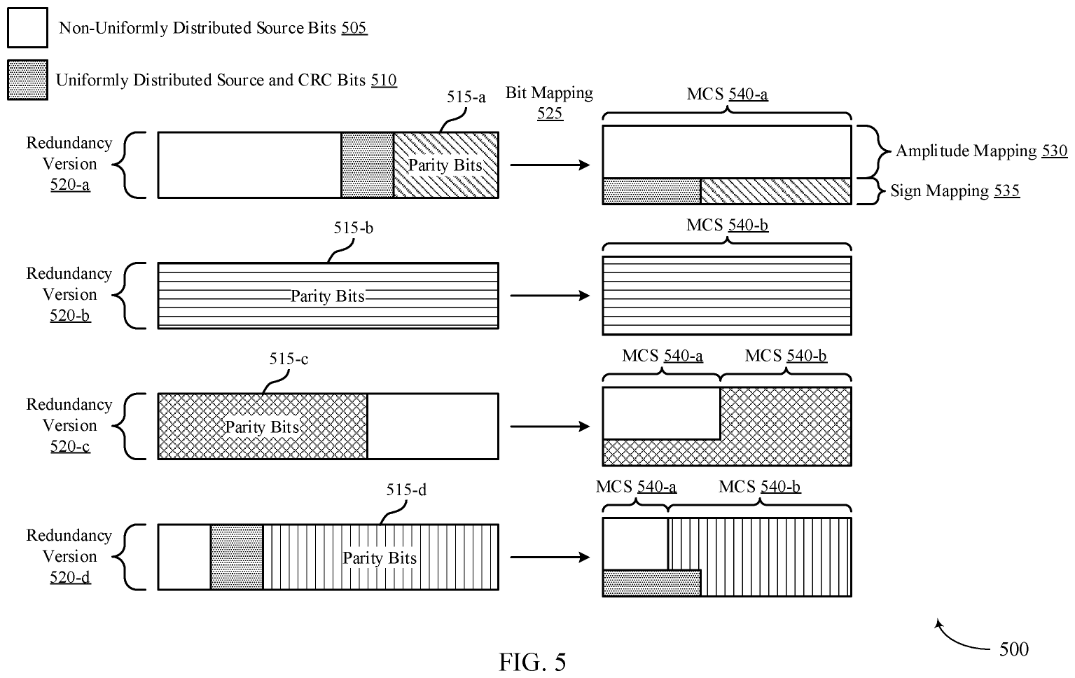

FIG. 5 illustrates an example of a bit mapping procedure 500 that supports a redundancy version configuration for a PCS scheme in accordance with aspects of the present disclosure. The bit mapping procedure 500 may be performed by a wireless device, such as a UE 115 or a base station 105, in a wireless communications system 100 or 200, as described with reference to FIGS. 1 and 2. The wireless device may determine a set of systematic bits and a set of parity bits for a message, for example, according to a process as described herein with reference to FIG. 3. The wireless device may determine a first MCS value 540-a and a second MCS value 540-b for modulating different redundancy versions 520 or portions of redundancy versions 520 as described herein with reference to FIG. 4 (e.g., based on one or more DCI messages). In some examples, the bit mapping procedure 500 may use a same redundancy version 520 selection procedure for a PCS scheme with non-uniformly distributed symbols as may be used for a redundancy version selection procedure with uniformly distributed symbols.

The wireless device may insert the set of systematic bits (e.g., including non-uniformly distributed source bits 505 and uniformly distributed source and CRC bits 510) and the set of parity bits 515 into a circular buffer. For each redundancy version 520, the wireless device may select bits sequentially from the circular buffer (e.g., according to a start position for the circular buffer). In some cases, the wireless device may store information (e.g., a table) indicating a start position for each redundancy version 520, where in some examples the start position may be further associated with an LDPC graph (e.g., LDPC base graph 1 or LDPC base graph 2). The bit selection process may result in a set of redundancy versions 520, where each redundancy version 520 may include non-uniformly distributed source bits 505, uniformly distributed source and CRC bits 510, uniformly distributed parity bits 515, or any combination thereof.

The wireless device may perform bit mapping 525 from the bits assigned for each redundancy version 520 to signals to transmit. The bit mapping 525 may map multiple bits to a same symbol, where the bits indicate different information about the symbol (e.g., an amplitude and a sign of the symbol). In some cases, the wireless device may determine the symbols for a signal using the non-uniformly distributed source bits 505 for amplitude mapping 530 and using the uniformly distributed source and CRC bits 510 and the uniformly distributed parity bits 515 for sign mapping 535. In some examples, based on the quantity of non-uniformly distributed bits selected for a specific redundancy version 520 of a message, the bits for the redundancy version 520 may not support using non-uniformly distributed bits for the amplitude mapping 530 for each symbol. Instead, a first portion of the signal may include symbols with non-uniformly distributed amplitude mapping 530 and a second portion of the signal may include symbols with uniformly distributed amplitude mapping 530, or the entire signal may include symbols with uniformly distributed amplitude mapping 530.

The wireless device may use a first MCS value 540-a to modulate the non-uniformly distributed portions of the signals and may use a second MCS value 540-b to modulate the uniformly distributed portions of the signals (e.g., as described with reference to FIG. 4). For example, the first redundancy version 520-a may include non-uniformly distributed source bits 505 for amplitude mapping 530 and uniformly distributed source and CRC bits 510 and uniformly distributed parity bits 515-a for sign mapping 535. Accordingly, the wireless device may use the first MCS value 540-a for modulating the signal for the redundancy version 520-a (e.g., based on the non-uniformly distributed bits for amplitude mapping 530). In contrast, the redundancy version 520-b may include uniformly distributed parity bits 515-b for amplitude mapping 530 and sign mapping 535. Accordingly, the wireless device may use the second MCS value 540-b for modulating the signal for the redundancy version 520-b (e.g., based on the uniformly distributed bits for amplitude mapping 530). The third redundancy version 520-c may include non-uniformly distributed source bits 505 for a first portion of amplitude mapping 530 and uniformly distributed parity bits 515-c for a second portion of amplitude mapping 530 and for sign mapping 535. Accordingly, the wireless device may use the first MCS value 540-a for modulating the first portion of the signal and the second MCS value 540-b for modulating the second portion of the signal for the redundancy version 520-c. Similarly, the wireless device may use the first MCS value 540-a and the second MCS value 540-b for modulating different portions of the signal for the fourth redundancy version 520-d based on using non-uniformly distributed source bits 505 for a first portion of amplitude mapping 530 and using uniformly distributed parity bits 515-d (or uniformly distributed source and CRC bits 510, or both) for a second portion of amplitude mapping 530.

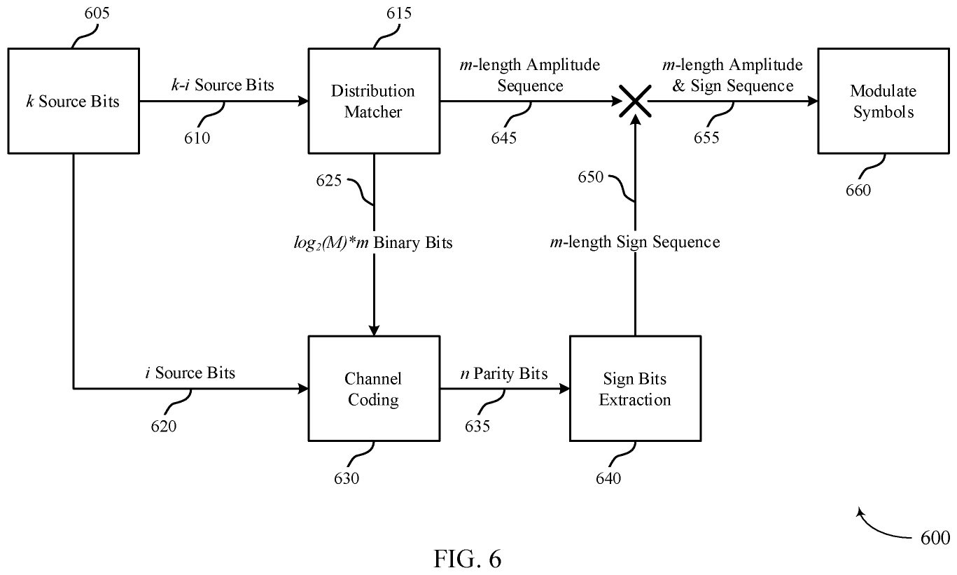

FIG. 6 illustrates an example of a PAS process 600 that supports a redundancy version configuration for a PCS scheme in accordance with aspects of the present disclosure. The PAS process 600 may be performed by a wireless device, such as a UE 115 or a base station 105, in a wireless communications system 100 or 200, as described with reference to FIGS. 1 and 2. In some examples, the wireless device may perform the PAS process 600 to generate a set of non-uniformly distributed symbols for transmission. As described herein with reference to FIGS. 3 through 5, the wireless device may use the determined bits to generate one or more redundancy versions of a message, where each redundancy version may include non-uniformly distributed symbols, uniformly distributed symbols, or a combination thereof.

At 605, the wireless device may determine a set of k source bits. The k source bits may represent information to send to another wireless device. In some examples, the source bits may be referred to as information bits. The wireless device may segment the k-length source bits into two parts: k−i source bits 610 and i source bits 620.

The wireless device may input the k−i source bits 610 into a distribution matcher 615. The distribution matcher 615 may be configured (e.g., pre-configured, dynamically configured) for a specific non-uniform distribution. The distribution matcher 615 may transform the sequence of k−i source bits 610 and output an m-length amplitude sequence 645 (e.g., based on the configured non-uniform distribution). For example, the m-length amplitude sequence 645 may be a non-uniform amplitude sequence supporting non-uniform symbol amplitude mapping, as described herein.

The wireless device (e.g., using the distribution matcher 615) may additionally transform the amplitude sequence into a binary sequence, for example, using a binary function b( ). The binary function may transform an M-array amplitude (e.g., including each amplitude sequence of the m-length amplitude sequence 645) using binary mapping to generate log₂(M)*m binary bits 625.

At 630, the wireless device may perform channel coding on the log₂(M)*m binary bits 625 and the i source bits 620 to create n-length parity bits 635. For example, the channel coding may involve LDPC encoding at a channel coder. At 640, the wireless device may concatenate the i source bits 620 with the n parity bits 635 to determine an m-length binary sequence. The m-length binary sequence may be used for sign mapping (e.g., an m-length sign sequence 650) and may be based on uniformly distributed bits (e.g., uniformly distributed i source bits 620 and n parity bits 635).

The wireless device may combine (e.g., multiply) the m-length amplitude sequence 645 with the m-length sign sequence 650 to determine an m-length amplitude and sign sequence 655 for modulation. At 660, the wireless device may modulate symbols using the m-length amplitude and sign sequence 655 and may transmit the modulated symbols in a signal. In some examples, the PAS process may illustrate a method for determining bits and modulation for an initial transmission (e.g., with redundancy version index 0). As described herein, other modulation techniques may be used for retransmissions (e.g., with redundancy version indexes greater than 0) based on the number of non-uniformly distributed bits included in each redundancy version.

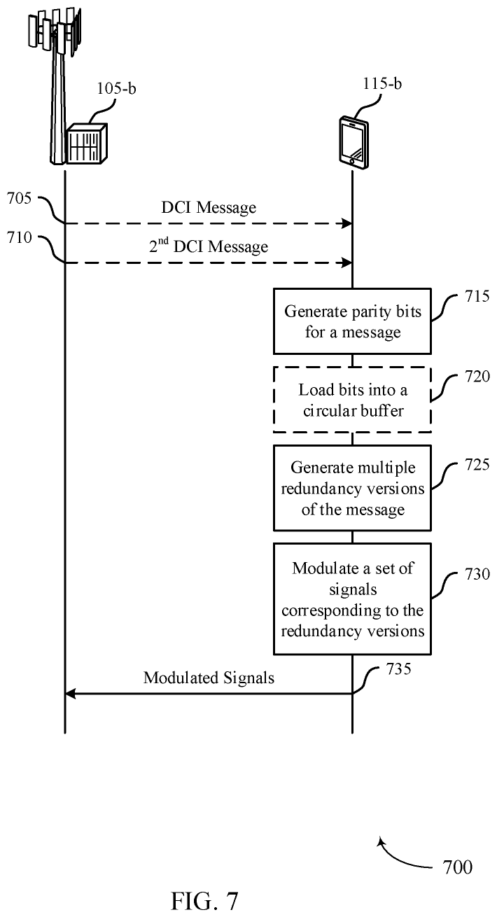

FIG. 7 illustrates an example of a process flow 700 that supports a redundancy version configuration for a PCS scheme in accordance with aspects of the present disclosure. The process flow 700 may include a UE 115-b and a base station 105-b, which may be examples of the corresponding wireless devices described with reference to FIGS. 1 through 6. Although the process flow 700 involves the UE 115-b performing redundancy version configuration, it is to be understood that the base station 105-b may additionally or alternatively perform redundancy version configuration. Alternative examples of the following may be implemented, where some processes are performed in a different order than described or are not performed at all. In some cases, processes may include additional features not mentioned below, or further processes may be added.

At 705, the base station 105-b may transmit a DCI message including an MCS field indicating an MCS index. The MCS index may correspond to one or more MCS values based on information (e.g., an MCS table) stored at the UE 115-b. In some examples, the DCI message may schedule or otherwise grant resources for an initial transmission of a message (e.g., with a redundancy version index equal to 0) by the UE 115-b. In some examples, at 710, the base station 105-b may additionally transmit a second DCI message including a second MCS field indicating a second MCS index. In some examples, the second DCI message may schedule or otherwise grant resources for a retransmission of the message (e.g., with a redundancy version index greater than 0). Based on receiving the DCI message at 705, the second DCI message at 710, or both, the UE 115-b may determine an MCS value or a set of MCS values (e.g., a first MCS value and a second MCS value). For example, a DCI message may include two MCS fields indicating the first MCS value and the second MCS value, a DCI message may include an MCS index that corresponds to the first MCS value and the second MCS value based on an MCS table configured at the UE 115-b, a first DCI message may include an MCS field indicating the first MCS value and a second DCI message may include an MCS field indicating the second MCS value, or some combination thereof.

At 715, the UE 115-b may generate a set of parity bits based on a set of systematic bits for a message. In some examples, the systematic bits may include source bits (e.g., information bits) and checking bits (e.g., CRC bits). In some cases, the UE 115-b may generate the parity bits based on LDPC encoding of the systematic bits.

At 720, the UE 115-b may load a set of bits into a buffer to support bit selection for a set of redundancy versions. In a first example, the UE 115-b may load the set of parity bits into a parity bit circular buffer. In a second example, the UE 115-b may load the set of systematic bits and the set of parity bits into either a shared buffer or separate buffers (e.g., a parity bit buffer and a systematic bit buffer). In a third example, the UE 115-b may load the set of systematic bits and the set of parity bits into a shared circular buffer.

At 725, the UE 115-b may generate a set of redundancy versions of the message based on the set of systematic bits and the set of parity bits. In a first example, each redundancy version may include the set of systematic bits and a respective subset of the set of parity bits. For example, the UE 115-b may select the respective subset of the set of parity bits sequentially from the set of parity bits loaded into a parity bit circular buffer based on a respective start position for the parity bit circular buffer corresponding to each redundancy version. In some examples, the UE 115-b may determine each respective start position for the parity bit circular buffer corresponding to each redundancy version based on information configured at the UE, such as a lookup table. The information (e.g., the lookup table) may define associations between each redundancy version (e.g., redundancy version index) and each respective start position for the parity bit circular buffer. The start positions for the redundancy versions may be equally spaced around the parity bit circular buffer relative to the other respective start positions or at least one start position may be unequally spaced around the parity bit circular buffer relative to at least one other start position.

In a second example, each redundancy version of the set of redundancy versions may include one or more bits of the set of systematic bits based on a respective systematic bit start position and one or more bits of the set of parity bits based on a respective parity bit start position, the respective systematic bit start positions and parity bit start positions corresponding to the redundancy versions. For example, the UE 115-b may select the one or more bits of the set of systematic bits sequentially from a circular buffer based on the respective systematic bit start position and may select the one or more bits of the set of parity bits sequentially from the circular buffer based on the respective parity bit start position for each redundancy version. In some cases, the UE 115-b may determine the start positions based on information (e.g., a lookup table) configured at the UE 115-b. For example, the information (e.g., lookup table) may define associations between the redundancy versions (e.g., redundancy version indexes), the respective systematic bit start positions, and the respective parity bit start positions. The associations may be MCS-specific or common across MCS values.

In a third example, each redundancy version may include one or more bits of the set of systematic bits, one or more bits of the set of parity bits, or some combination thereof. For example, the UE 115-b may select the bits sequentially from a circular buffer including both the set of systematic bits and the set of parity bits according to a start position corresponding to a respective redundancy version (e.g., redundancy version index).

At 730, the UE 115-b may modulate a set of signals corresponding to the set of redundancy versions of the message. At 735, the UE 115-b may transmit the set of modulated signals (e.g., as repetitions of a message, for example, including an initial transmission and one or more retransmissions of the message).

In a first example, the UE 115-b may modulate the set of signals based on the set of systematic bits and the respective subset of the set of parity bits for the respective redundancy versions of the set of redundancy versions. For example, the UE 115-b may modulate each signal using the set of systematic bits for amplitude mapping and the respective subset of the set of parity bits for the respective redundancy version for sign mapping. In some examples, the UE 115-b may use non-uniformly distributed bits (e.g., the systematic bits, other bits, or both) for amplitude mapping and uniformly distributed bits (e.g., the parity bits, other bits, or both) for sign mapping. The UE 115-b may use a same MCS value for modulating the set of signals.

In a second example, the UE 115-b may modulate the set of signals based on the one or more bits of the set of systematic bits and the one or more bits of the set of parity bits for each respective redundancy version of the set of redundancy versions. For example, the UE 115-b may modulate a first portion of the set of signals using a first MCS value (e.g., indicated by a DCI message) and may modulate a second portion of the set of signals using a second MCS value (e.g., indicated by the same or a different DCI message). The first portion may include a non-uniform distribution for amplitude mapping and the second portion may include a uniform distribution for amplitude mapping.

In a third example, the UE 115-b may modulate a first portion of the of the set of signals using a first MCS value (e.g., indicated by a DCI message) and may modulate a second portion of the set of signals using a second MCS value (e.g., indicated by the same or a different DCI message). The first portion may include a non-uniform distribution for amplitude mapping and the second portion may include a uniform distribution for amplitude mapping. In some cases, a specific redundancy version may be modulated using the first MCS value (e.g., if the redundancy version includes the set of systematic bits), modulated using the second MCS value (e.g., if the redundancy version does not include systematic bits), or modulated using the first MCS value and the second MCS value (e.g., if the redundancy version includes a subset of the set of systematic bits).

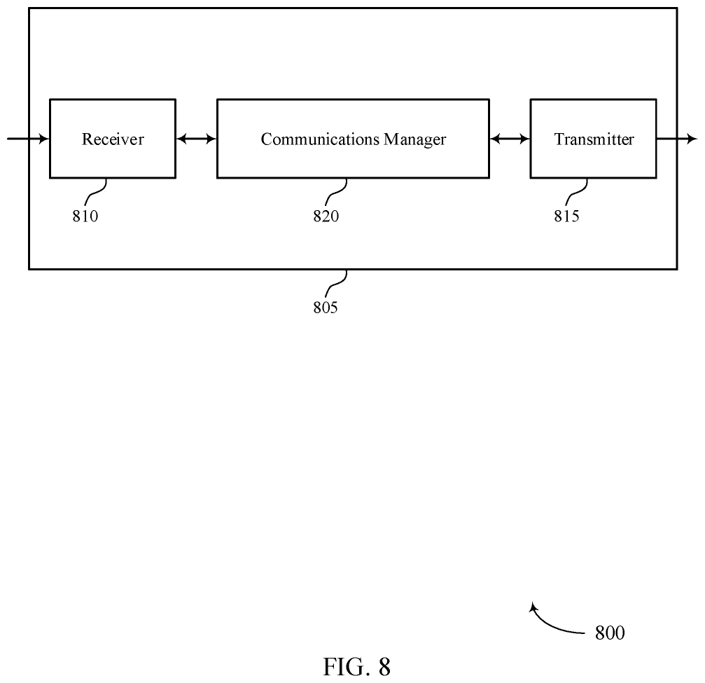

FIG. 8 shows a block diagram 800 of a device 805 that supports a redundancy version configuration for a PCS scheme in accordance with aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to redundancy version configuration for a PCS scheme). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to redundancy version configuration for a PCS scheme). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of redundancy version configuration for a PCS scheme as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communications at a UE in accordance with examples as disclosed herein. For example, the communications manager 820 may be configured as or otherwise support a means for generating a set of parity bits based on a set of systematic bits for a message. The communications manager 820 may be configured as or otherwise support a means for generating a set of multiple redundancy versions of the message, each redundancy version of the set of multiple redundancy versions including the set of systematic bits and a respective subset of the set of parity bits. The communications manager 820 may be configured as or otherwise support a means for modulating a set of multiple signals corresponding to the set of multiple redundancy versions of the message based on the set of systematic bits and the respective subset of the set of parity bits for the respective redundancy versions of the set of multiple redundancy versions. The communications manager 820 may be configured as or otherwise support a means for transmitting the set of multiple modulated signals.

Additionally or alternatively, the communications manager 820 may support wireless communications at a UE in accordance with examples as disclosed herein. For example, the communications manager 820 may be configured as or otherwise support a means for generating a set of parity bits based on a set of systematic bits for a message. The communications manager 820 may be configured as or otherwise support a means for generating a set of multiple redundancy versions of the message, each redundancy version of the set of multiple redundancy versions including one or more of the set of systematic bits based on a respective systematic bit start position and one or more of the set of parity bits based on a respective parity bit start position. The communications manager 820 may be configured as or otherwise support a means for modulating a set of multiple signals corresponding to the set of multiple redundancy versions of the message based on the one or more of the set of systematic bits and the one or more of the set of parity bits for the respective redundancy versions of the set of multiple redundancy versions. The communications manager 820 may be configured as or otherwise support a means for transmitting the set of multiple modulated signals.

Additionally or alternatively, the communications manager 820 may support wireless communications at a UE in accordance with examples as disclosed herein. For example, the communications manager 820 may be configured as or otherwise support a means for generating a set of parity bits based on a set of systematic bits for a message. The communications manager 820 may be configured as or otherwise support a means for generating a set of multiple redundancy versions of the message, each redundancy version of the set of multiple redundancy versions including one or more of the set of systematic bits, one or more of the set of parity bits, or both. The communications manager 820 may be configured as or otherwise support a means for modulating a set of multiple signals corresponding to the set of multiple redundancy versions of the message based on the one or more of the set of systematic bits for each redundancy version, the one or more of the set of parity bits for each redundancy version, or both, where the modulating includes modulating a first portion of the set of multiple signals using a first MCS value, the first portion including a non-uniform distribution for amplitude mapping, and modulating a second portion of the set of multiple signals using a second MCS value, the second portion including a uniform distribution for amplitude mapping. The communications manager 820 may be configured as or otherwise support a means for transmitting the set of multiple modulated signals.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for improving communication reliability. For example, the communications manager 820 may support both a shaping gain (e.g., using a PCS scheme) and a coding gain (e.g., using different redundancy versions for retransmission of a message), providing improved reliability for transmissions of a message (e.g., using multiple redundancy versions). Improved communication reliability may reduce a number of retransmissions requested by a wireless device (e.g., triggered by a negative acknowledgment (NACK) or no response in a HARQ procedure). Reducing the number of retransmissions may reduce a number of times the processor ramps up processing power and turns on processing units to handle message retransmissions.

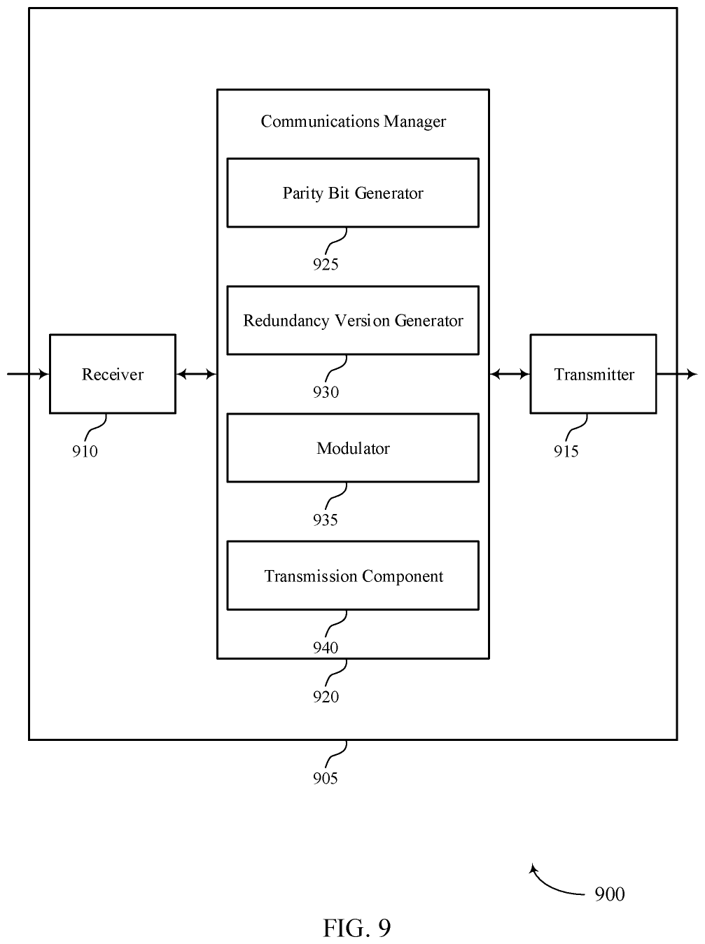

FIG. 9 shows a block diagram 900 of a device 905 that supports a redundancy version configuration for a PCS scheme in accordance with aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to redundancy version configuration for a PCS scheme). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to redundancy version configuration for a PCS scheme). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of redundancy version configuration for a PCS scheme as described herein. For example, the communications manager 920 may include a parity bit generator 925, a redundancy version generator 930, a modulator 935, a transmission component 940, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a UE in accordance with examples as disclosed herein. The parity bit generator 925 may be configured as or otherwise support a means for generating a set of parity bits based on a set of systematic bits for a message. The redundancy version generator 930 may be configured as or otherwise support a means for generating a set of multiple redundancy versions of the message, each redundancy version of the set of multiple redundancy versions including the set of systematic bits and a respective subset of the set of parity bits. The modulator 935 may be configured as or otherwise support a means for modulating a set of multiple signals corresponding to the set of multiple redundancy versions of the message based on the set of systematic bits and the respective subset of the set of parity bits for the respective redundancy versions of the set of multiple redundancy versions. The transmission component 940 may be configured as or otherwise support a means for transmitting the set of multiple modulated signals.

Additionally or alternatively, the communications manager 920 may support wireless communications at a UE in accordance with examples as disclosed herein. The parity bit generator 925 may be configured as or otherwise support a means for generating a set of parity bits based on a set of systematic bits for a message. The redundancy version generator 930 may be configured as or otherwise support a means for generating a set of multiple redundancy versions of the message, each redundancy version of the set of multiple redundancy versions including one or more of the set of systematic bits based on a respective systematic bit start position and one or more of the set of parity bits based on a respective parity bit start position. The modulator 935 may be configured as or otherwise support a means for modulating a set of multiple signals corresponding to the set of multiple redundancy versions of the message based on the one or more of the set of systematic bits and the one or more of the set of parity bits for the respective redundancy versions of the set of multiple redundancy versions. The transmission component 940 may be configured as or otherwise support a means for transmitting the set of multiple modulated signals.

Additionally or alternatively, the communications manager 920 may support wireless communications at a UE in accordance with examples as disclosed herein. The parity bit generator 925 may be configured as or otherwise support a means for generating a set of parity bits based on a set of systematic bits for a message. The redundancy version generator 930 may be configured as or otherwise support a means for generating a set of multiple redundancy versions of the message, each redundancy version of the set of multiple redundancy versions including one or more of the set of systematic bits, one or more of the set of parity bits, or both. The modulator 935 may be configured as or otherwise support a means for modulating a set of multiple signals corresponding to the set of multiple redundancy versions of the message based on the one or more of the set of systematic bits for each redundancy version, the one or more of the set of parity bits for each redundancy version, or both. The modulating may include the modulator 935 being configured as or otherwise support a means for modulating a first portion of the set of multiple signals using a first MCS value, the first portion including a non-uniform distribution for amplitude mapping, and modulating a second portion of the set of multiple signals using a second MCS value, the second portion including a uniform distribution for amplitude mapping. The transmission component 940 may be configured as or otherwise support a means for transmitting the set of multiple modulated signals.

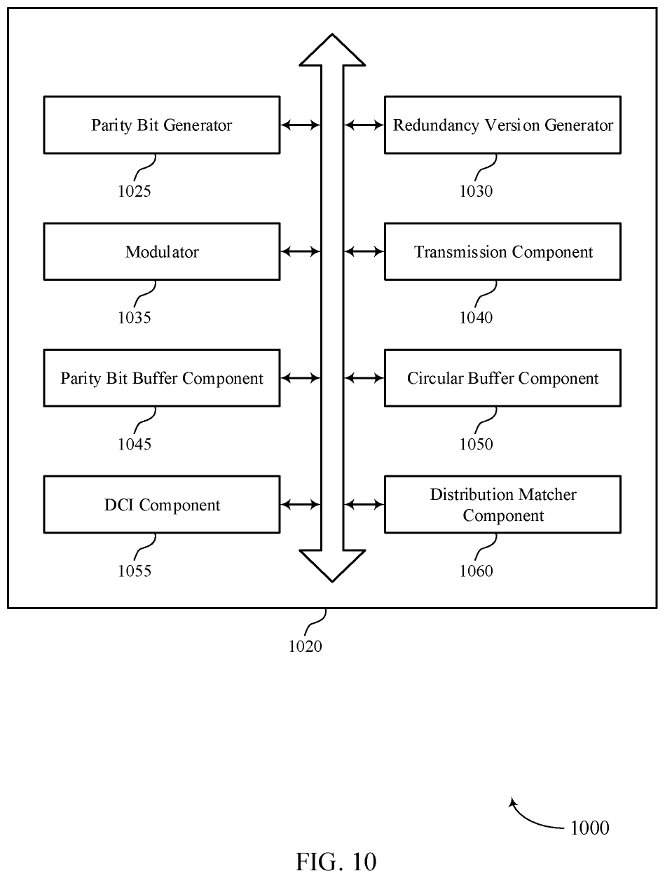

FIG. 10 shows a block diagram 1000 of a communications manager 1020 that supports a redundancy version configuration for a PCS scheme in accordance with aspects of the present disclosure. The communications manager 1020 may be an example of aspects of a communications manager 820, a communications manager 920, or both, as described herein. The communications manager 1020, or various components thereof, may be an example of means for performing various aspects of redundancy version configuration for a PCS scheme as described herein. For example, the communications manager 1020 may include a parity bit generator 1025, a redundancy version generator 1030, a modulator 1035, a transmission component 1040, a parity bit buffer component 1045, a circular buffer component 1050, a DCI component 1055, a distribution matcher component 1060, or any combination thereof. Each of these components may communicate, directly or indirectly, with one another (e.g., via one or more buses).

The communications manager 1020 may support wireless communications at a UE in accordance with examples as disclosed herein. The parity bit generator 1025 may be configured as or otherwise support a means for generating a set of parity bits based on a set of systematic bits for a message. The redundancy version generator 1030 may be configured as or otherwise support a means for generating a set of multiple redundancy versions of the message, each redundancy version of the set of multiple redundancy versions including the set of systematic bits and a respective subset of the set of parity bits. The modulator 1035 may be configured as or otherwise support a means for modulating a set of multiple signals corresponding to the set of multiple redundancy versions of the message based on the set of systematic bits and the respective subset of the set of parity bits for the respective redundancy versions of the set of multiple redundancy versions. The transmission component 1040 may be configured as or otherwise support a means for transmitting the set of multiple modulated signals.

In some examples, the parity bit buffer component 1045 may be configured as or otherwise support a means for loading the set of parity bits into a parity bit circular buffer. In some examples, the parity bit buffer component 1045 may be configured as or otherwise support a means for determining the respective subset of the set of parity bits for each redundancy version of the set of multiple redundancy versions based on the parity bit circular buffer, where generating the set of multiple redundancy versions of the message is based on determining the respective subset of the set of parity bits for each redundancy version of the set of multiple redundancy versions.

In some examples, to support determining the respective subset of the set of parity bits for each redundancy version, the parity bit buffer component 1045 may be configured as or otherwise support a means for selecting the respective subset of the set of parity bits sequentially from the set of parity bits loaded into the parity bit circular buffer based on a respective start position for the parity bit circular buffer corresponding to each redundancy version.

In some examples, the parity bit buffer component 1045 may be configured as or otherwise support a means for determining each respective start position for the parity bit circular buffer corresponding to each redundancy version based on information configured at the UE, the information defining associations between each redundancy version and each respective start position for the parity bit circular buffer.

In some examples, each respective start position for the parity bit circular buffer corresponding to each redundancy version is equally spaced around the parity bit circular buffer relative to the other respective start positions.

In some other examples, at least one start position of a set of multiple start positions for the parity bit circular buffer corresponding to the set of multiple redundancy versions is unequally spaced around the parity bit circular buffer relative to at least one other start position of the set of multiple start positions for the parity bit circular buffer.

In some examples, to support modulating the set of multiple signals, the modulator 1035 may be configured as or otherwise support a means for modulating each signal of the set of multiple signals corresponding to a respective redundancy version of the set of multiple redundancy versions of the message using the set of systematic bits for amplitude mapping and the respective subset of the set of parity bits for the respective redundancy version for sign mapping.

In some examples, the distribution matcher component 1060 may be configured as or otherwise support a means for determining the amplitude mapping based on a distribution matcher configured with a non-uniform distribution. In some examples, to support determining the amplitude mapping, the distribution matcher component 1060 may be configured as or otherwise support a means for inputting the systematic bits into the distribution matcher. In some examples, to support determining the amplitude mapping, the distribution matcher component 1060 may be configured as or otherwise support a means for outputting the systematic bits from the distribution matcher with the non-uniform distribution.

In some examples, each of the set of multiple signals is modulated using a same MCS value.

Additionally or alternatively, the communications manager 1020 may support wireless communications at a UE in accordance with examples as disclosed herein. In some examples, the parity bit generator 1025 may be configured as or otherwise support a means for generating a set of parity bits based on a set of systematic bits for a message. In some examples, the redundancy version generator 1030 may be configured as or otherwise support a means for generating a set of multiple redundancy versions of the message, each redundancy version of the set of multiple redundancy versions including one or more of the set of systematic bits based on a respective systematic bit start position and one or more of the set of parity bits based on a respective parity bit start position. In some examples, the modulator 1035 may be configured as or otherwise support a means for modulating a set of multiple signals corresponding to the set of multiple redundancy versions of the message based on the one or more of the set of systematic bits and the one or more of the set of parity bits for the respective redundancy versions of the set of multiple redundancy versions. In some examples, the transmission component 1040 may be configured as or otherwise support a means for transmitting the set of multiple modulated signals.

In some examples, the circular buffer component 1050 may be configured as or otherwise support a means for loading the set of systematic bits and the set of parity bits into a circular buffer. In some examples, the circular buffer component 1050 may be configured as or otherwise support a means for selecting the one or more of the set of systematic bits sequentially from the set of systematic bits loaded into the circular buffer based on the respective systematic bit start position for the circular buffer corresponding to each redundancy version. In some examples, the circular buffer component 1050 may be configured as or otherwise support a means for selecting the one or more of the set of parity bits sequentially from the set of parity bits loaded into the circular buffer based on the respective parity bit start position for the circular buffer corresponding to each redundancy version, where generating the set of multiple redundancy versions of the message is based on selecting the one or more of the set of systematic bits sequentially from the set of systematic bits loaded into the circular buffer and selecting the one or more of the set of parity bits sequentially from the set of parity bits loaded into the circular buffer.

In some examples, the circular buffer component 1050 may be configured as or otherwise support a means for determining each respective systematic bit start position and each respective parity bit start position for the circular buffer corresponding to each redundancy version based on information configured at the UE, the information defining associations between each redundancy version, the respective systematic bit start position, and the respective parity bit start position, where selecting the one or more of the set of systematic bits and selecting the one or more of the set of parity bits is based on determining each respective systematic bit start position and each respective parity bit start position for the circular buffer.

In some examples, the associations between each redundancy version, the respective systematic bit start position, and the respective parity bit start position are independent of MCS values.

In some other examples, the information defines the associations between MCS values, each redundancy version, the respective systematic bit start position, and the respective parity bit start position.

In some examples, to support modulating, the modulator 1035 may be configured as or otherwise support a means for modulating a first portion of the set of multiple signals using a first MCS value, the first portion including a non-uniform distribution for amplitude mapping. In some examples, to support modulating, the modulator 1035 may be configured as or otherwise support a means for modulating a second portion of the set of multiple signals using a second MCS value, the second portion including a uniform distribution for amplitude mapping.

In some examples, the DCI component 1055 may be configured as or otherwise support a means for receiving a DCI message including a first MCS field indicating the first MCS value and a second MCS field indicating the second MCS value, where modulating the set of multiple signals is based on the DCI message.

In some other examples, the DCI component 1055 may be configured as or otherwise support a means for receiving a DCI message including an MCS field indicating an MCS index. In some examples, to support the modulating, the modulator 1035 may be configured as or otherwise support a means for modulating a first signal corresponding to an initial transmission of the message using the first MCS value based on initial transmission information defining an association between the MCS index and the first MCS value. In some examples, to support the modulating, the modulator 1035 may be configured as or otherwise support a means for modulating one or more additional signals corresponding to one or more retransmissions of the message using the first MCS value, the second MCS value, or both based on retransmission information defining an association between the MCS index and both the first MCS value and the second MCS value.

In yet some other examples, the DCI component 1055 may be configured as or otherwise support a means for receiving a first DCI message including a first MCS field indicating the first MCS value and scheduling an initial transmission of the message. In some examples, the DCI component 1055 may be configured as or otherwise support a means for receiving a second DCI message including a second MCS field indicating the second MCS value and scheduling a retransmission of the message. In some examples, to support modulating the set of multiple signals, the modulator 1035 may be configured as or otherwise support a means for modulating a first signal corresponding to the initial transmission of the message using the first MCS value based on the first MCS field. In some examples, to support modulating the set of multiple signals, the modulator 1035 may be configured as or otherwise support a means for modulating one or more additional signals corresponding to one or more retransmissions of the message using the first MCS value, the second MCS value, or both based on the first MCS field and the second MCS field.

Additionally or alternatively, the communications manager 1020 may support wireless communications at a UE in accordance with examples as disclosed herein. In some examples, the parity bit generator 1025 may be configured as or otherwise support a means for generating a set of parity bits based on a set of systematic bits for a message. In some examples, the redundancy version generator 1030 may be configured as or otherwise support a means for generating a set of multiple redundancy versions of the message, each redundancy version of the set of multiple redundancy versions including one or more of the set of systematic bits, one or more of the set of parity bits, or both. In some examples, the modulator 1035 may be configured as or otherwise support a means for modulating a set of multiple signals corresponding to the set of multiple redundancy versions of the message based on the one or more of the set of systematic bits for each redundancy version, the one or more of the set of parity bits for each redundancy version, or both. In some examples, to support the modulating, the modulator 1035 may be configured as or otherwise support a means for modulating a first portion of the set of multiple signals using a first MCS value, the first portion including a non-uniform distribution for amplitude mapping. In some examples, to support the modulating, the modulator 1035 may be configured as or otherwise support a means for modulating a second portion of the set of multiple signals using a second MCS value, the second portion including a uniform distribution for amplitude mapping. In some examples, the transmission component 1040 may be configured as or otherwise support a means for transmitting the set of multiple modulated signals.

In some examples, the DCI component 1055 may be configured as or otherwise support a means for receiving a DCI message including a first MCS field indicating the first MCS value and a second MCS field indicating the second MCS value, where modulating the set of multiple signals is based on the DCI message.

In some other examples, the DCI component 1055 may be configured as or otherwise support a means for receiving a DCI message including an MCS field indicating an MCS index. In some examples, to support modulating the set of multiple signals, the modulator 1035 may be configured as or otherwise support a means for modulating a first signal corresponding to an initial transmission of the message using the first MCS value based on initial transmission information defining an association between the MCS index and the first MCS value. In some examples, to support modulating the set of multiple signals, the modulator 1035 may be configured as or otherwise support a means for modulating one or more additional signals corresponding to one or more retransmissions of the message using the first MCS value, the second MCS value, or both based on retransmission information defining an association between the MCS index and both the first MCS value and the second MCS value.

In yet some other examples, the DCI component 1055 may be configured as or otherwise support a means for receiving a first DCI message including a first MCS field indicating the first MCS value and scheduling an initial transmission of the message. In some examples, the DCI component 1055 may be configured as or otherwise support a means for receiving a second DCI message including a second MCS field indicating the second MCS value and scheduling a retransmission of the message. In some examples, to support modulating the set of multiple signals, the modulator 1035 may be configured as or otherwise support a means for modulating a first signal corresponding to the initial transmission of the message using the first MCS value based on the first MCS field. In some examples, to support modulating the set of multiple signals, the modulator 1035 may be configured as or otherwise support a means for modulating one or more additional signals corresponding to one or more retransmissions of the message using the first MCS value, the second MCS value, or both based on the first MCS field and the second MCS field.

In some examples, the circular buffer component 1050 may be configured as or otherwise support a means for loading the set of systematic bits and the set of parity bits into a circular buffer. In some examples, the circular buffer component 1050 may be configured as or otherwise support a means for selecting the one or more of the set of systematic bits, the one or more of the set of parity bits, or both sequentially from the set of systematic bits and the set of parity bits loaded into the circular buffer based on a respective start position for the circular buffer corresponding to each redundancy version.

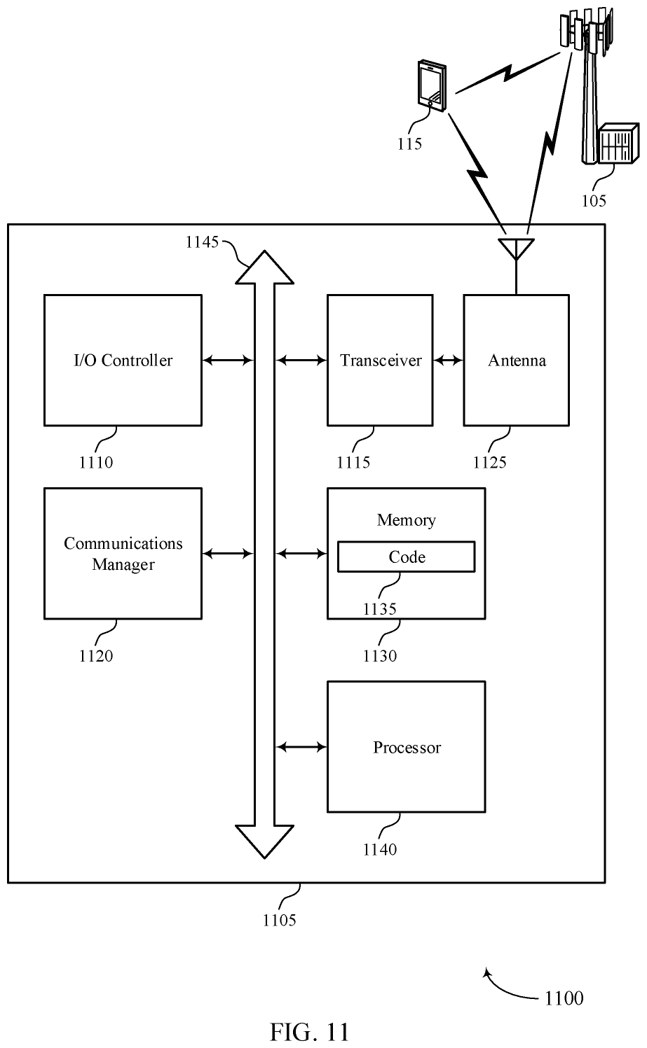

FIG. 11 shows a diagram of a system 1100 including a device 1105 that supports a redundancy version configuration for a PCS scheme in accordance with aspects of the present disclosure. The device 1105 may be an example of or include the components of a device 805, a device 905, or a UE 115 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting redundancy version configuration for a PCS scheme). For example, the device 1105 or a component of the device 1105 may include a processor 1140 and memory 1130 coupled to the processor 1140, the processor 1140 and memory 1130 configured to perform various functions described herein.

The communications manager 1120 may support wireless communications at a UE in accordance with examples as disclosed herein. For example, the communications manager 1120 may be configured as or otherwise support a means for generating a set of parity bits based on a set of systematic bits for a message. The communications manager 1120 may be configured as or otherwise support a means for generating a set of multiple redundancy versions of the message, each redundancy version of the set of multiple redundancy versions including the set of systematic bits and a respective subset of the set of parity bits. The communications manager 1120 may be configured as or otherwise support a means for modulating a set of multiple signals corresponding to the set of multiple redundancy versions of the message based on the set of systematic bits and the respective subset of the set of parity bits for the respective redundancy versions of the set of multiple redundancy versions. The communications manager 1120 may be configured as or otherwise support a means for transmitting the set of multiple modulated signals.

Additionally or alternatively, the communications manager 1120 may support wireless communications at a UE in accordance with examples as disclosed herein. For example, the communications manager 1120 may be configured as or otherwise support a means for generating a set of parity bits based on a set of systematic bits for a message. The communications manager 1120 may be configured as or otherwise support a means for generating a set of multiple redundancy versions of the message, each redundancy version of the set of multiple redundancy versions including one or more of the set of systematic bits based on a respective systematic bit start position and one or more of the set of parity bits based on a respective parity bit start position. The communications manager 1120 may be configured as or otherwise support a means for modulating a set of multiple signals corresponding to the set of multiple redundancy versions of the message based on the one or more of the set of systematic bits and the one or more of the set of parity bits for the respective redundancy versions of the set of multiple redundancy versions. The communications manager 1120 may be configured as or otherwise support a means for transmitting the set of multiple modulated signals.

Additionally or alternatively, the communications manager 1120 may support wireless communications at a UE in accordance with examples as disclosed herein. For example, the communications manager 1120 may be configured as or otherwise support a means for generating a set of parity bits based on a set of systematic bits for a message. The communications manager 1120 may be configured as or otherwise support a means for generating a set of multiple redundancy versions of the message, each redundancy version of the set of multiple redundancy versions including one or more of the set of systematic bits, one or more of the set of parity bits, or both. The communications manager 1120 may be configured as or otherwise support a means for modulating a set of multiple signals corresponding to the set of multiple redundancy versions of the message based on the one or more of the set of systematic bits for each redundancy version, the one or more of the set of parity bits for each redundancy version, or both. The modulating may include modulating a first portion of the set of multiple signals using a first MCS value, the first portion including a non-uniform distribution for amplitude mapping, and modulating a second portion of the set of multiple signals using a second MCS value, the second portion including a uniform distribution for amplitude mapping. The communications manager 1120 may be configured as or otherwise support a means for transmitting the set of multiple modulated signals.

By including or configuring the communications manager 1120 in accordance with examples as described herein, the device 1105 may support techniques for improving communication reliability. For example, the communications manager 1120 may support both a shaping gain (e.g., using a PCS scheme) and a coding gain (e.g., using different redundancy versions for retransmission of a message), providing improved reliability for transmissions of a message (e.g., using multiple redundancy versions). Improved communication reliability may reduce the latency involved in successfully receiving and decoding a message. Additionally, improving communication reliability may reduce a total number of retransmissions performed in a wireless communications system, effectively reducing the channel overhead.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of redundancy version configuration for a PCS scheme as described herein, or the processor 1140 and the memory 1130 may be otherwise configured to perform or support such operations.

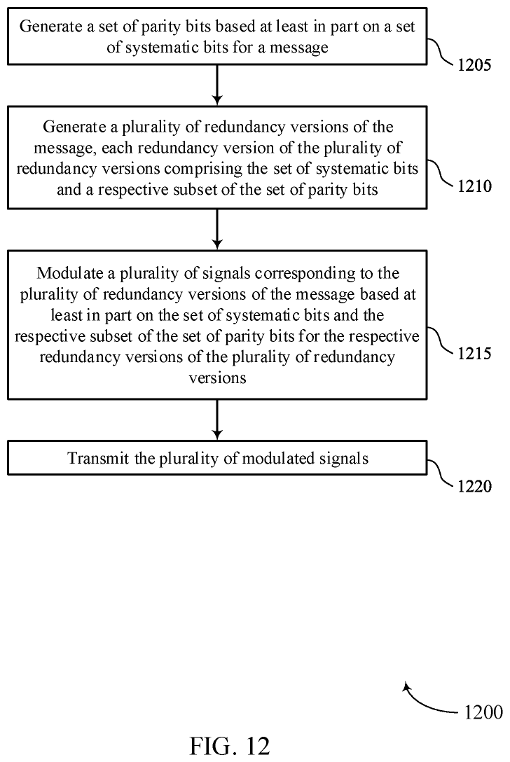

FIG. 12 shows a flowchart illustrating a method 1200 that supports a redundancy version configuration for a PCS scheme in accordance with aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1205, the method may include generating a set of parity bits based on a set of systematic bits for a message. The operations of 1205 may be performed in accordance with examples as disclosed herein. In some examples, aspects of the operations of 1205 may be performed by a parity bit generator 1025 as described with reference to FIG. 10.

At 1210, the method may include generating a set of multiple redundancy versions of the message, each redundancy version of the set of multiple redundancy versions including the set of systematic bits and a respective subset of the set of parity bits. The operations of 1210 may be performed in accordance with examples as disclosed herein. In some examples, aspects of the operations of 1210 may be performed by a redundancy version generator 1030 as described with reference to FIG. 10.

At 1215, the method may include modulating a set of multiple signals corresponding to the set of multiple redundancy versions of the message based on the set of systematic bits and the respective subset of the set of parity bits for the respective redundancy versions of the set of multiple redundancy versions. The operations of 1215 may be performed in accordance with examples as disclosed herein. In some examples, aspects of the operations of 1215 may be performed by a modulator 1035 as described with reference to FIG. 10.

At 1220, the method may include transmitting the set of multiple modulated signals. The operations of 1220 may be performed in accordance with examples as disclosed herein. In some examples, aspects of the operations of 1220 may be performed by a transmission component 1040 as described with reference to FIG. 10.

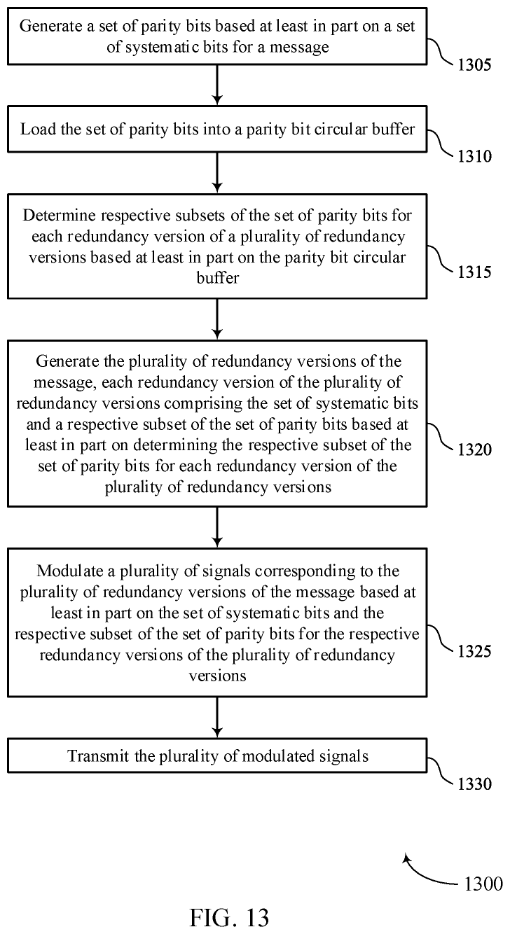

FIG. 13 shows a flowchart illustrating a method 1300 that supports a redundancy version configuration for a PCS scheme in accordance with aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1305, the method may include generating a set of parity bits based on a set of systematic bits for a message. The operations of 1305 may be performed in accordance with examples as disclosed herein. In some examples, aspects of the operations of 1305 may be performed by a parity bit generator 1025 as described with reference to FIG. 10.

At 1310, the method may include loading the set of parity bits into a parity bit circular buffer. The operations of 1310 may be performed in accordance with examples as disclosed herein. In some examples, aspects of the operations of 1310 may be performed by a parity bit buffer component 1045 as described with reference to FIG. 10.

At 1315, the method may include determining a respective subset of the set of parity bits for each redundancy version of a set of multiple redundancy versions based on the parity bit circular buffer. The operations of 1315 may be performed in accordance with examples as disclosed herein. In some examples, aspects of the operations of 1315 may be performed by a parity bit buffer component 1045 as described with reference to FIG. 10.

At 1320, the method may include generating the set of multiple redundancy versions of the message, each redundancy version of the set of multiple redundancy versions including the set of systematic bits and the respective subset of the set of parity bits based on determining the respective subsets of the parity bits from the parity bit circular buffer. The operations of 1320 may be performed in accordance with examples as disclosed herein. In some examples, aspects of the operations of 1320 may be performed by a redundancy version generator 1030 as described with reference to FIG. 10.

At 1325, the method may include modulating a set of multiple signals corresponding to the set of multiple redundancy versions of the message based on the set of systematic bits and the respective subset of the set of parity bits for the respective redundancy versions of the set of multiple redundancy versions. The operations of 1325 may be performed in accordance with examples as disclosed herein. In some examples, aspects of the operations of 1325 may be performed by a modulator 1035 as described with reference to FIG. 10.

At 1330, the method may include transmitting the set of multiple modulated signals. The operations of 1330 may be performed in accordance with examples as disclosed herein. In some examples, aspects of the operations of 1330 may be performed by a transmission component 1040 as described with reference to FIG. 10.

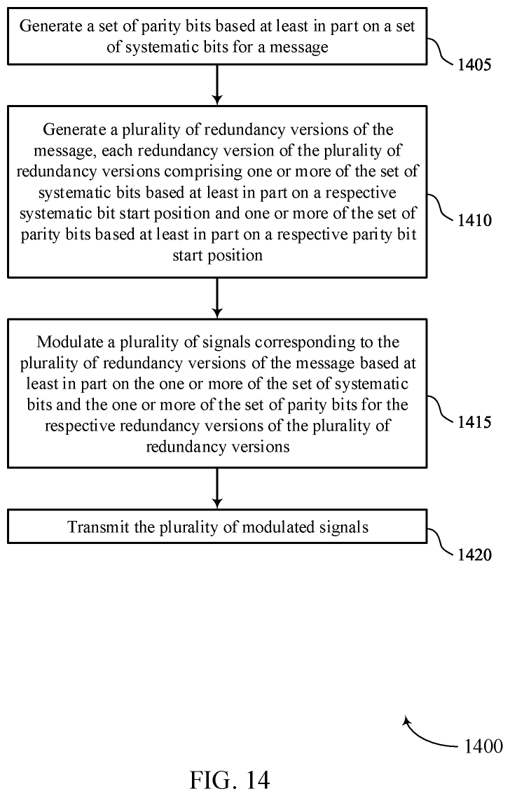

FIG. 14 shows a flowchart illustrating a method 1400 that supports a redundancy version configuration for a PCS scheme in accordance with aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1405, the method may include generating a set of parity bits based on a set of systematic bits for a message. The operations of 1405 may be performed in accordance with examples as disclosed herein. In some examples, aspects of the operations of 1405 may be performed by a parity bit generator 1025 as described with reference to FIG. 10.

At 1410, the method may include generating a set of multiple redundancy versions of the message, each redundancy version of the set of multiple redundancy versions including one or more of the set of systematic bits based on a respective systematic bit start position and one or more of the set of parity bits based on a respective parity bit start position. The operations of 1410 may be performed in accordance with examples as disclosed herein. In some examples, aspects of the operations of 1410 may be performed by a redundancy version generator 1030 as described with reference to FIG. 10.

At 1415, the method may include modulating a set of multiple signals corresponding to the set of multiple redundancy versions of the message based on the one or more of the set of systematic bits and the one or more of the set of parity bits for the respective redundancy versions of the set of multiple redundancy versions. The operations of 1415 may be performed in accordance with examples as disclosed herein. In some examples, aspects of the operations of 1415 may be performed by a modulator 1035 as described with reference to FIG. 10.

At 1420, the method may include transmitting the set of multiple modulated signals. The operations of 1420 may be performed in accordance with examples as disclosed herein. In some examples, aspects of the operations of 1420 may be performed by a transmission component 1040 as described with reference to FIG. 10.

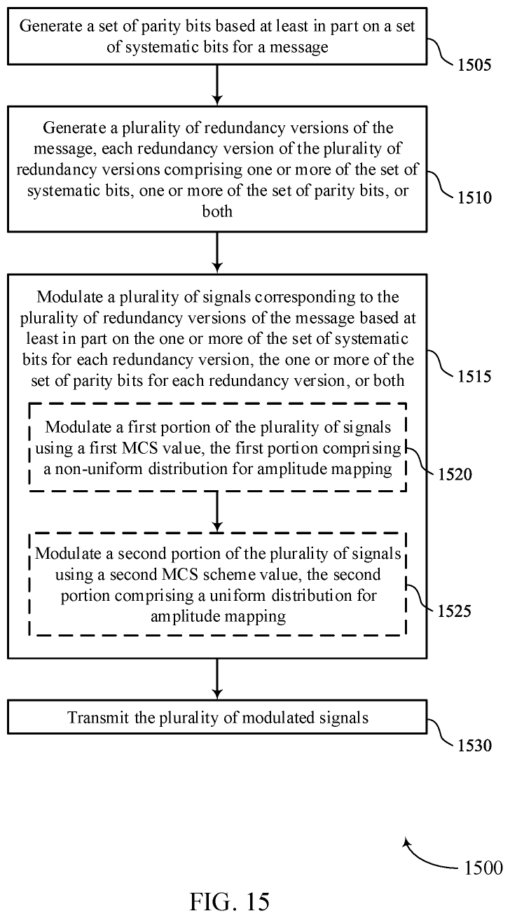

FIG. 15 shows a flowchart illustrating a method 1500 that supports a redundancy version configuration for a PCS scheme in accordance with aspects of the present disclosure. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1505, the method may include generating a set of parity bits based on a set of systematic bits for a message. The operations of 1505 may be performed in accordance with examples as disclosed herein. In some examples, aspects of the operations of 1505 may be performed by a parity bit generator 1025 as described with reference to FIG. 10.

At 1510, the method may include generating a set of multiple redundancy versions of the message, each redundancy version of the set of multiple redundancy versions including one or more of the set of systematic bits, one or more of the set of parity bits, or both. The operations of 1510 may be performed in accordance with examples as disclosed herein. In some examples, aspects of the operations of 1510 may be performed by a redundancy version generator 1030 as described with reference to FIG. 10.

At 1515, the method may include modulating a set of multiple signals corresponding to the set of multiple redundancy versions of the message based on the one or more of the set of systematic bits for each redundancy version, the one or more of the set of parity bits for each redundancy version, or both. The operations of 1515 may be performed in accordance with examples as disclosed herein. In some examples, aspects of the operations of 1515 may be performed by a modulator 1035 as described with reference to FIG. 10.

At 1520, the method may include modulating a first portion of the set of multiple signals using a first MCS value, the first portion including a non-uniform distribution for amplitude mapping. The operations of 1520 may be performed in accordance with examples as disclosed herein. In some examples, aspects of the operations of 1520 may be performed by a modulator 1035 as described with reference to FIG. 10.

At 1525, the method may include modulating a second portion of the set of multiple signals using a second MCS value, the second portion including a uniform distribution for amplitude mapping. The operations of 1525 may be performed in accordance with examples as disclosed herein. In some examples, aspects of the operations of 1525 may be performed by a modulator 1035 as described with reference to FIG. 10.

At 1530, the method may include transmitting the set of multiple modulated signals. The operations of 1530 may be performed in accordance with examples as disclosed herein. In some examples, aspects of the operations of 1530 may be performed by a transmission component 1040 as described with reference to FIG. 10.

The following provides an overview of aspects of the present disclosure:

Aspect 1: A method for wireless communications at a UE, comprising: generating a set of parity bits based at least in part on a set of systematic bits for a message; generating a plurality of redundancy versions of the message, each redundancy version of the plurality of redundancy versions comprising the set of systematic bits and a respective subset of the set of parity bits; modulating a plurality of signals corresponding to the plurality of redundancy versions of the message based at least in part on the set of systematic bits and the respective subset of the set of parity bits for the respective redundancy versions of the plurality of redundancy versions; and transmitting the plurality of modulated signals.

Aspect 2: The method of aspect 1, further comprising: loading the set of parity bits into a parity bit circular buffer; and determining the respective subset of the set of parity bits for each redundancy version of the plurality of redundancy versions based at least in part on the parity bit circular buffer, wherein generating the plurality of redundancy versions of the message is based at least in part on determining the respective subset of the set of parity bits for each redundancy version of the plurality of redundancy versions.

Aspect 3: The method of aspect 2, wherein determining the respective subset of the set of parity bits for each redundancy version comprises: selecting the respective subset of the set of parity bits sequentially from the set of parity bits loaded into the parity bit circular buffer based at least in part on a respective start position for the parity bit circular buffer corresponding to each redundancy version.

Aspect 4: The method of aspect 3, further comprising: determining each respective start position for the parity bit circular buffer corresponding to each redundancy version based at least in part on information configured at the UE, the information defining associations between each redundancy version and each respective start position for the parity bit circular buffer.

Aspect 5: The method of any of aspects 3 through 4, wherein each respective start position for the parity bit circular buffer corresponding to each redundancy version is equally spaced around the parity bit circular buffer relative to the other respective start positions.

Aspect 6: The method of any of aspects 3 through 4, wherein at least one start position of a plurality of start positions for the parity bit circular buffer corresponding to the plurality of redundancy versions is unequally spaced around the parity bit circular buffer relative to at least one other start position of the plurality of start positions for the parity bit circular buffer.

Aspect 7: The method of any of aspects 1 through 6, wherein modulating the plurality of signals comprises: modulating each signal of the plurality of signals corresponding to a respective redundancy version of the plurality of redundancy versions of the message using the set of systematic bits for amplitude mapping and the respective subset of the set of parity bits for the respective redundancy version for sign mapping.

Aspect 8: The method of aspect 7, further comprising: determining the amplitude mapping based at least in part on a distribution matcher configured with a non-uniform distribution, the determining the amplitude mapping comprising: inputting the systematic bits into the distribution matcher; and outputting the systematic bits from the distribution matcher with the non-uniform distribution.

Aspect 9: The method of any of aspects 1 through 8, wherein each of the plurality of signals is modulated using a same modulation and coding scheme value.

Aspect 10: A method for wireless communications at a UE, comprising: generating a set of parity bits based at least in part on a set of systematic bits for a message; generating a plurality of redundancy versions of the message, each redundancy version of the plurality of redundancy versions comprising one or more of the set of systematic bits based at least in part on a respective systematic bit start position and one or more of the set of parity bits based at least in part on a respective parity bit start position; modulating a plurality of signals corresponding to the plurality of redundancy versions of the message based at least in part on the one or more of the set of systematic bits and the one or more of the set of parity bits for the respective redundancy versions of the plurality of redundancy versions; and transmitting the plurality of modulated signals.

Aspect 11: The method of aspect 10, further comprising: loading the set of systematic bits and the set of parity bits into a circular buffer; selecting the one or more of the set of systematic bits sequentially from the set of systematic bits loaded into the circular buffer based at least in part on the respective systematic bit start position for the circular buffer corresponding to each redundancy version; and selecting the one or more of the set of parity bits sequentially from the set of parity bits loaded into the circular buffer based at least in part on the respective parity bit start position for the circular buffer corresponding to each redundancy version, wherein generating the plurality of redundancy versions of the message is based at least in part on selecting the one or more of the set of systematic bits sequentially from the set of systematic bits loaded into the circular buffer and selecting the one or more of the set of parity bits sequentially from the set of parity bits loaded into the circular buffer.

Aspect 12: The method of aspect 11, further comprising: determining each respective systematic bit start position and each respective parity bit start position for the circular buffer corresponding to each redundancy version based at least in part on information configured at the UE, the information defining associations between each redundancy version, the respective systematic bit start position, and the respective parity bit start position, wherein selecting the one or more of the set of systematic bits and selecting the one or more of the set of parity bits is based at least in part on determining each respective systematic bit start position and each respective parity bit start position for the circular buffer.

Aspect 13: The method of aspect 12, wherein the associations between each redundancy version, the respective systematic bit start position, and the respective parity bit start position are independent of modulation and coding scheme values.

Aspect 14: The method of aspect 12, wherein the information defines the associations between modulation and coding scheme values, each redundancy version, the respective systematic bit start position, and the respective parity bit start position.

Aspect 15: The method of any of aspects 10 through 14, wherein the modulating comprises: modulating a first portion of the plurality of signals using a first modulation and coding scheme value, the first portion comprising a non-uniform distribution for amplitude mapping; and modulating a second portion of the plurality of signals using a second modulation and coding scheme value, the second portion comprising a uniform distribution for amplitude mapping.

Aspect 16: The method of aspect 15, further comprising: receiving a downlink control information message comprising a first modulation and coding scheme field indicating the first modulation and coding scheme value and a second modulation and coding scheme field indicating the second modulation and coding scheme value, wherein modulating the plurality of signals is based at least in part on the downlink control information message.

Aspect 17: The method of aspect 15, further comprising: receiving a downlink control information message comprising a modulation and coding scheme field indicating a modulation and coding scheme index, wherein the modulating the plurality of signals comprises: modulating a first signal corresponding to an initial transmission of the message using the first modulation and coding scheme value based at least in part on initial transmission information defining an association between the modulation and coding scheme index and the first modulation and coding scheme value; and modulating one or more additional signals corresponding to one or more retransmissions of the message using the first modulation and coding scheme value, the second modulation and coding scheme value, or both based at least in part on retransmission information defining an association between the modulation and coding scheme index and both the first modulation and coding scheme value and the second modulation and coding scheme value.

Aspect 18: The method of aspect 15, further comprising: receiving a first downlink control information message comprising a first modulation and coding scheme field indicating the first modulation and coding scheme value and scheduling an initial transmission of the message; and receiving a second downlink control information message comprising a second modulation and coding scheme field indicating the second modulation and coding scheme value and scheduling a retransmission of the message, wherein the modulating the plurality of signals comprises: modulating a first signal corresponding to the initial transmission of the message using the first modulation and coding scheme value based at least in part on the first modulation and coding scheme field; and modulating one or more additional signals corresponding to one or more retransmissions of the message using the first modulation and coding scheme value, the second modulation and coding scheme value, or both based at least in part on the first modulation and coding scheme field and the second modulation and coding scheme field.

Aspect 19: A method for wireless communications at a UE, comprising: generating a set of parity bits based at least in part on a set of systematic bits for a message; generating a plurality of redundancy versions of the message, each redundancy version of the plurality of redundancy versions comprising one or more of the set of systematic bits, one or more of the set of parity bits, or both; modulating a plurality of signals corresponding to the plurality of redundancy versions of the message based at least in part on the one or more of the set of systematic bits for each redundancy version, the one or more of the set of parity bits for each redundancy version, or both, wherein the modulating comprises: modulating a first portion of the plurality of signals using a first modulation and coding scheme value, the first portion comprising a non-uniform distribution for amplitude mapping; and modulating a second portion of the plurality of signals using a second modulation and coding scheme value, the second portion comprising a uniform distribution for amplitude mapping; and transmitting the plurality of modulated signals.

Aspect 20: The method of aspect 19, further comprising: receiving a downlink control information message comprising a first modulation and coding scheme field indicating the first modulation and coding scheme value and a second modulation and coding scheme field indicating the second modulation and coding scheme value, wherein modulating the plurality of signals is based at least in part on the downlink control information message.

Aspect 21: The method of aspect 19, further comprising: receiving a downlink control information message comprising a modulation and coding scheme field indicating a modulation and coding scheme index, wherein the modulating the plurality of signals comprises: modulating a first signal corresponding to an initial transmission of the message using the first modulation and coding scheme value based at least in part on initial transmission information defining an association between the modulation and coding scheme index and the first modulation and coding scheme value; and modulating one or more additional signals corresponding to one or more retransmissions of the message using the first modulation and coding scheme value, the second modulation and coding scheme value, or both based at least in part on retransmission information defining an association between the modulation and coding scheme index and both the first modulation and coding scheme value and the second modulation and coding scheme value.

Aspect 22: The method of aspect 19, further comprising: receiving a first downlink control information message comprising a first modulation and coding scheme field indicating the first modulation and coding scheme value and scheduling an initial transmission of the message; and receiving a second downlink control information message comprising a second modulation and coding scheme field indicating the second modulation and coding scheme value and scheduling a retransmission of the message, wherein the modulating the plurality of signals comprises: modulating a first signal corresponding to the initial transmission of the message using the first modulation and coding scheme value based at least in part on the first modulation and coding scheme field; and modulating one or more additional signals corresponding to one or more retransmissions of the message using the first modulation and coding scheme value, the second modulation and coding scheme value, or both based at least in part on the first modulation and coding scheme field and the second modulation and coding scheme field.

Aspect 23: The method of any of aspects 19 through 22, further comprising: loading the set of systematic bits and the set of parity bits into a circular buffer; and selecting the one or more of the set of systematic bits, the one or more of the set of parity bits, or both sequentially from the set of systematic bits and the set of parity bits loaded into the circular buffer based at least in part on a respective start position for the circular buffer corresponding to each redundancy version.

Aspect 24: An apparatus for wireless communications at a UE, comprising a processor, memory coupled with the processor, and instructions stored in the memory and executable by the processor to cause the apparatus to perform a method of any of aspects 1 through 9.

Aspect 25: An apparatus for wireless communications at a UE, comprising at least one means for performing a method of any of aspects 1 through 9.

Aspect 26: A non-transitory computer-readable medium storing code for wireless communications at a UE, the code comprising instructions executable by a processor to perform a method of any of aspects 1 through 9.

Aspect 27: An apparatus for wireless communications at a UE, comprising a processor, memory coupled with the processor, and instructions stored in the memory and executable by the processor to cause the apparatus to perform a method of any of aspects 10 through 18.

Aspect 28: An apparatus for wireless communications at a UE, comprising at least one means for performing a method of any of aspects 10 through 18.

Aspect 29: A non-transitory computer-readable medium storing code for wireless communications at a UE, the code comprising instructions executable by a processor to perform a method of any of aspects 10 through 18.

Aspect 30: An apparatus for wireless communications at a UE, comprising a processor, memory coupled with the processor, and instructions stored in the memory and executable by the processor to cause the apparatus to perform a method of any of aspects 19 through 23.

Aspect 31: An apparatus for wireless communications at a UE, comprising at least one means for performing a method of any of aspects 19 through 23.

Aspect 32: A non-transitory computer-readable medium storing code for wireless communications at a UE, the code comprising instructions executable by a processor to perform a method of any of aspects 19 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
generating a set of parity bits based at least in part on a set of systematic bits for a message;
generating a plurality of redundancy versions of the message, each redundancy version of the plurality of redundancy versions comprising the set of systematic bits and a respective subset of the set of parity bits;
modulating a plurality of signals corresponding to the plurality of redundancy versions of the message based at least in part on the set of systematic bits and the respective subset of the set of parity bits for the respective redundancy versions of the plurality of redundancy versions; and
transmitting the plurality of modulated signals.

2. The method of claim 1, further comprising:
loading the set of parity bits into a parity bit circular buffer; and
determining the respective subset of the set of parity bits for each redundancy version of the plurality of redundancy versions based at least in part on the parity bit circular buffer, wherein generating the plurality of redundancy versions of the message is based at least in part on determining the respective subset of the set of parity bits for each redundancy version of the plurality of redundancy versions.

3. The method of claim 2, wherein determining the respective subset of the set of parity bits for each redundancy version comprises:
selecting the respective subset of the set of parity bits sequentially from the set of parity bits loaded into the parity bit circular buffer based at least in part on a respective start position for the parity bit circular buffer corresponding to each redundancy version.

4. The method of claim 3, further comprising:
determining each respective start position for the parity bit circular buffer corresponding to each redundancy version based at least in part on information configured at the UE, the information defining associations between each redundancy version and each respective start position for the parity bit circular buffer.

5. The method of claim 3, wherein each respective start position for the parity bit circular buffer corresponding to each redundancy version is equally spaced around the parity bit circular buffer relative to the other respective start positions.

6. The method of claim 3, wherein at least one start position of a plurality of start positions for the parity bit circular buffer corresponding to the plurality of redundancy versions is unequally spaced around the parity bit circular buffer relative to at least one other start position of the plurality of start positions for the parity bit circular buffer.

7. The method of claim 1, wherein modulating the plurality of signals comprises:
modulating each signal of the plurality of signals corresponding to a respective redundancy version of the plurality of redundancy versions of the message using the set of systematic bits for amplitude mapping and the respective subset of the set of parity bits for the respective redundancy version for sign mapping.

8. The method of claim 7, further comprising:
determining the amplitude mapping based at least in part on a distribution matcher configured with a non-uniform distribution, the determining the amplitude mapping comprising:
inputting the systematic bits into the distribution matcher; and
outputting the systematic bits from the distribution matcher with the non-uniform distribution.

9. The method of claim 1, wherein each of the plurality of signals is modulated using a same modulation and coding scheme value.

10. A method for wireless communications at a user equipment (UE), comprising:
generating a set of parity bits based at least in part on a set of systematic bits for a message;
generating a plurality of redundancy versions of the message, each redundancy version of the plurality of redundancy versions comprising one or more of the set of systematic bits based at least in part on a respective systematic bit start position and one or more of the set of parity bits based at least in part on a respective parity bit start position;
modulating a plurality of signals corresponding to the plurality of redundancy versions of the message based at least in part on the one or more of the set of systematic bits and the one or more of the set of parity bits for the respective redundancy versions of the plurality of redundancy versions; and
transmitting the plurality of modulated signals.

11. The method of claim 10, further comprising:
loading the set of systematic bits and the set of parity bits into a circular buffer;
selecting the one or more of the set of systematic bits sequentially from the set of systematic bits loaded into the circular buffer based at least in part on the respective systematic bit start position for the circular buffer corresponding to each redundancy version; and
selecting the one or more of the set of parity bits sequentially from the set of parity bits loaded into the circular buffer based at least in part on the respective parity bit start position for the circular buffer corresponding to each redundancy version, wherein generating the plurality of redundancy versions of the message is based at least in part on selecting the one or more of the set of systematic bits sequentially from the set of systematic bits loaded into the circular buffer and selecting the one or more of the set of parity bits sequentially from the set of parity bits loaded into the circular buffer.

12. The method of claim 11, further comprising:
determining each respective systematic bit start position and each respective parity bit start position for the circular buffer corresponding to each redundancy version based at least in part on information configured at the UE, the information defining associations between each redundancy version, the respective systematic bit start position, and the respective parity bit start position, wherein selecting the one or more of the set of systematic bits and selecting the one or more of the set of parity bits is based at least in part on determining each respective systematic bit start position and each respective parity bit start position for the circular buffer.

13. The method of claim 12, wherein the associations between each redundancy version, the respective systematic bit start position, and the respective parity bit start position are independent of modulation and coding scheme values.

14. The method of claim 12, wherein the information defines the associations between modulation and coding scheme values, each redundancy version, the respective systematic bit start position, and the respective parity bit start position.

15. The method of claim 10, wherein the modulating comprises:
modulating a first portion of the plurality of signals using a first modulation and coding scheme value, the first portion comprising a non-uniform distribution for amplitude mapping; and
modulating a second portion of the plurality of signals using a second modulation and coding scheme value, the second portion comprising a uniform distribution for amplitude mapping.

16. The method of claim 15, further comprising:
receiving a downlink control information message comprising a first modulation and coding scheme field indicating the first modulation and coding scheme value and a second modulation and coding scheme field indicating the second modulation and coding scheme value, wherein modulating the plurality of signals is based at least in part on the downlink control information message.

17. The method of claim 15, further comprising:
receiving a downlink control information message comprising a modulation and coding scheme field indicating a modulation and coding scheme index, wherein the modulating the plurality of signals comprises:
modulating a first signal corresponding to an initial transmission of the message using the first modulation and coding scheme value based at least in part on initial transmission information defining an association between the modulation and coding scheme index and the first modulation and coding scheme value; and
modulating one or more additional signals corresponding to one or more retransmissions of the message using the first modulation and coding scheme value, the second modulation and coding scheme value, or both based at least in part on retransmission information defining an association between the modulation and coding scheme index and both the first modulation and coding scheme value and the second modulation and coding scheme value.

18. The method of claim 15, further comprising:
receiving a first downlink control information message comprising a first modulation and coding scheme field indicating the first modulation and coding scheme value and scheduling an initial transmission of the message; and
receiving a second downlink control information message comprising a second modulation and coding scheme field indicating the second modulation and coding scheme value and scheduling a retransmission of the message, wherein the modulating the plurality of signals comprises:
modulating a first signal corresponding to the initial transmission of the message using the first modulation and coding scheme value based at least in part on the first modulation and coding scheme field; and
modulating one or more additional signals corresponding to one or more retransmissions of the message using the first modulation and coding scheme value, the second modulation and coding scheme value, or both based at least in part on the first modulation and coding scheme field and the second modulation and coding scheme field.

19. A method for wireless communications at a user equipment (UE), comprising:
generating a set of parity bits based at least in part on a set of systematic bits for a message;
generating a plurality of redundancy versions of the message, each redundancy version of the plurality of redundancy versions comprising one or more of the set of systematic bits, one or more of the set of parity bits, or both;
modulating a plurality of signals corresponding to the plurality of redundancy versions of the message based at least in part on the one or more of the set of systematic bits for each redundancy version, the one or more of the set of parity bits for each redundancy version, or both, wherein the modulating comprises:
modulating a first portion of the plurality of signals using a first modulation and coding scheme value, the first portion comprising a non-uniform distribution for amplitude mapping; and
modulating a second portion of the plurality of signals using a second modulation and coding scheme value, the second portion comprising a uniform distribution for amplitude mapping; and
transmitting the plurality of modulated signals.

20. The method of claim 19, further comprising:
receiving a downlink control information message comprising a first modulation and coding scheme field indicating the first modulation and coding scheme value and a second modulation and coding scheme field indicating the second modulation and coding scheme value, wherein modulating the plurality of signals is based at least in part on the downlink control information message.

21. The method of claim 19, further comprising:
receiving a downlink control information message comprising a modulation and coding scheme field indicating a modulation and coding scheme index, wherein the modulating the plurality of signals comprises:
modulating a first signal corresponding to an initial transmission of the message using the first modulation and coding scheme value based at least in part on initial transmission information defining an association between the modulation and coding scheme index and the first modulation and coding scheme value; and
modulating one or more additional signals corresponding to one or more retransmissions of the message using the first modulation and coding scheme value, the second modulation and coding scheme value, or both based at least in part on retransmission information defining an association between the modulation and coding scheme index and both the first modulation and coding scheme value and the second modulation and coding scheme value.

22. The method of claim 19, further comprising:
receiving a first downlink control information message comprising a first modulation and coding scheme field indicating the first modulation and coding scheme value and scheduling an initial transmission of the message; and
receiving a second downlink control information message comprising a second modulation and coding scheme field indicating the second modulation and coding scheme value and scheduling a retransmission of the message, wherein the modulating the plurality of signals comprises:
modulating a first signal corresponding to the initial transmission of the message using the first modulation and coding scheme value based at least in part on the first modulation and coding scheme field; and
modulating one or more additional signals corresponding to one or more retransmissions of the message using the first modulation and coding scheme value, the second modulation and coding scheme value, or both based at least in part on the first modulation and coding scheme field and the second modulation and coding scheme field.

23. The method of claim 19, further comprising:
loading the set of systematic bits and the set of parity bits into a circular buffer; and
selecting the one or more of the set of systematic bits, the one or more of the set of parity bits, or both sequentially from the set of systematic bits and the set of parity bits loaded into the circular buffer based at least in part on a respective start position for the circular buffer corresponding to each redundancy version.

24. An apparatus for wireless communications at a user equipment (UE), comprising a processor, memory coupled with the processor, and instructions stored in the memory and executable by the processor to cause the apparatus to:
generate a set of parity bits based at least in part on a set of systematic bits for a message;
generate a plurality of redundancy versions of the message, each redundancy version of the plurality of redundancy versions comprising the set of systematic bits and a respective subset of the set of parity bits;
modulate a plurality of signals corresponding to the plurality of redundancy versions of the message based at least in part on the set of systematic bits and the respective subset of the set of parity bits for the respective redundancy versions of the plurality of redundancy versions; and
transmit the plurality of modulated signals.

25. The apparatus of claim 24, wherein the instructions are further executable by the processor to cause the apparatus to:
load the set of parity bits into a parity bit circular buffer; and
determine the respective subset of the set of parity bits for each redundancy version of the plurality of redundancy versions based at least in part on the parity bit circular buffer, wherein generating the plurality of redundancy versions of the message is based at least in part on determining the respective subset of the set of parity bits for each redundancy version of the plurality of redundancy versions.

26. The apparatus of claim 25, wherein the instructions to determine the respective subset of the set of parity bits for each redundancy version are executable by the processor to cause the apparatus to:
select the respective subset of the set of parity bits sequentially from the set of parity bits loaded into the parity bit circular buffer based at least in part on a respective start position for the parity bit circular buffer corresponding to each redundancy version.

27. The apparatus of claim 26, wherein the instructions are further executable by the processor to cause the apparatus to:
determine each respective start position for the parity bit circular buffer corresponding to each redundancy version based at least in part on information configured at the UE, the information defining associations between each redundancy version and each respective start position for the parity bit circular buffer.

28. The apparatus of claim 24, wherein the instructions to modulate the plurality of signals are executable by the processor to cause the apparatus to:
modulate each signal of the plurality of signals corresponding to a respective redundancy version of the plurality of redundancy versions of the message using the set of systematic bits for amplitude mapping and the respective subset of the set of parity bits for the respective redundancy version for sign mapping.

29. The apparatus of claim 28, wherein the instructions are further executable by the processor to cause the apparatus to:
determine the amplitude mapping based at least in part on a distribution matcher configured with a non-uniform distribution, the instructions to determine the amplitude mapping executable by the processor to cause the apparatus to:
input the systematic bits into the distribution matcher; and
output the systematic bits from the distribution matcher with the non-uniform distribution.

30. The apparatus of claim 24, wherein each of the plurality of signals is modulated using a same modulation and coding scheme value.
